(19) United States
(12) Patent Application Publication
(10) Pub. No.: US 2026/0349499 A1
(43) Pub. Date: Nov. 5, 2026

(54) INFORMATION PROCESSING DEVICE, INFORMATION PROCESSING METHOD, AND PROGRAM

(71) Applicant: Sony Group Corporation, Tokyo (JP)

(72) Inventors: Daisuke KIKUCHI, Kanagawa (JP); Hisakazu SHIRAKI, Kanagawa (JP); Ryota YAMADA, Kanagawa (JP); Koji KASHIMA, Kanagawa (JP); Wataru OTORI, Tokyo (JP)

(73) Assignee: Sony Group Corporation, Tokyo (JP)

(21) Appl. No.: 19/478,064

(22) PCT Filed: Apr. 15, 2024
(86) PCT No.: PCT/JP2024/014972

§ 371 Date: Oct. 23, 2025

(30) Foreign Application Priority Data
May 1, 2023 (JP) 2023-075470

(51) Int. Cl. G06F 3/01; G06T 11/00; G06V 20/40; G06V 40/10

(52) U.S. Cl. CPC G06F 3/011; G06T 11/00; G06V 20/40; G06V 40/10

(57) ABSTRACT

There is provided an information processing device, a method, and a program capable of supporting a user in responding promptly and reducing risks. The information processing device detects an external intervener with respect to a user wearing a device that blocks an external sight and sound, and performs control for presenting information regarding the detected intervener to the user. The present technology can be applied to an ambient computing system.

### TECHNICAL FIELD

The present technology relates to an information processing device, a method, and a program, and more particularly, to an information processing device, a method, and a program capable of supporting a user in responding promptly and reducing risks.

### BACKGROUND ART

With improvement in performance of a head-mounted display (HMD) and advancement in a virtual reality (VR) content generation technology, experience (viewing) of a VR space and viewing of VR content have become common. At this time, although a user generally wears an HMD, the user often does not notice surrounding obstacles or intervention (call or the like) of a person since visibility of surroundings, sound, and the like are blocked when the user wears an HMD.

As for surrounding obstacles, for example, Patent Document 1 proposes a technique for detecting a real obstacle around a user, replacing the obstacle with a virtual object, and displaying the virtual object on a screen of an HMD. Patent Literature 1, however, does not describe detection of human intervention.

### CITATION LIST

### Patent Document

Patent Document 1: Japanese Patent Application Laid-Open No. 2013-257716

### SUMMARY OF THE INVENTION

### Problems to be Solved by the Invention

A risk of not noticing human intervention with an HMD on during viewing of VR content described above is expected to increase in the future. Furthermore, even in a case where human intervention is noticed, it is necessary to take time and effort to detach and attach an HMD or leave a VR space in order to, for example, communicate with the person.

The present technology has been developed in view of such circumstances, and is intended to support a user in responding promptly and reduce risks.

### Solutions to Problems

An information processing device according to an aspect of the present technology includes a detection unit that detects an external intervener with respect to a user wearing a user device that blocks an external sight and sound, and a presentation control unit that performs control for presenting information regarding the detected intervener to the user.

In the aspect of the present technology, an external intervener with respect to a user wearing a user device that blocks an external sight and sound is detected, and control for presenting information regarding the detected intervener to the user is performed.

### BRIEF DESCRIPTION OF DRAWINGS

FIG. 1 is a block diagram illustrating a configuration example of an ambient computing system according to an embodiment of the present technology.

FIG. 2 is a diagram illustrating an outline of an HMD system according to the first embodiment of the present technology.

FIG. 3 is a block diagram illustrating a configuration example of an HMD system in FIG. 2.

FIG. 4 is a block diagram illustrating a configuration example of a detection unit in FIG. 3.

FIG. 5 is a flowchart illustrating a process by the HMD system in FIG. 2.

FIG. 6 is a flowchart illustrating a detection process in step S11 in FIG. 5.

FIG. 7 is a diagram illustrating a modification of the HMD system in FIG. 2.

FIG. 8 is a flowchart illustrating another process by the HMD system in FIG. 2.

FIG. 9 is a flowchart illustrating a detection process in step S51 in FIG. 8.

FIG. 10 is a flowchart illustrating another example of the detection process in step S51 in FIG. 8.

FIG. 11 is a diagram illustrating an outline of an HMD system according to a second embodiment of the present technology.

FIG. 12 is a block diagram illustrating a configuration example of an HMD system in FIG. 11.

FIG. 13 is a flowchart illustrating a process by the HMD system in FIG. 11.

FIG. 14 is a block diagram illustrating a configuration example of an HMD system according to a third embodiment of the present technology.

FIG. 15 is a diagram illustrating an outline of an HMD system according to a fourth embodiment of the present technology.

FIG. 16 is a block diagram illustrating a configuration example of an HMD system in FIG. 15.

FIG. 17 is a block diagram illustrating a configuration example of an HMD system according to a fifth embodiment of the present technology.

FIG. 18 is a flowchart illustrating a process by the HMD system in FIG. 17.

FIG. 19 is a diagram illustrating communication between a user and an intervener.

FIG. 20 is a diagram illustrating a display method in a case where a video of an intervener is presented to the user.

FIG. 21 is a flowchart illustrating another process by the HMD system in FIG. 17.

FIG. 22 is a block diagram illustrating a configuration example of an HMD system according to a sixth embodiment of the present technology.

FIG. 23 is a flowchart illustrating a process by the HMD system in FIG. 22.

FIG. 24 is a diagram illustrating a method for presenting a message to a person who has spoken to the user.

FIG. 25 is a diagram illustrating an outline of an HMD system according to a seventh embodiment of the present technology.

FIG. 26 is a diagram illustrating an outline of an HMD system according to an eighth embodiment of the present technology.

FIG. 27 is a flowchart illustrating a process by the HMD system in FIG. 26.

FIG. 28 is a flowchart illustrating a first control process according to an intervention level by an HMD system according to a ninth embodiment of the present technology.

FIG. 29 is a diagram illustrating a control method based on whether the user and the intervener are adults or children.

FIG. 30 is a flowchart illustrating a second control process according to the intervention level by the HMD system according to the ninth embodiment of the present technology.

FIG. 31 is a diagram illustrating an example of a control method determination table.

FIG. 32 is a diagram illustrating an example of a VR space viewed or experienced by the user.

FIG. 33 is a block diagram illustrating a configuration example of a computer.

### MODE FOR CARRYING OUT THE INVENTION

Modes for carrying out the present technology will be described hereinafter. The description will be given in the following order.
1. Overall System
2. First Embodiment of Present Technology (Notification of Intervention Detection)
3. Second Embodiment of Present Technology (Superimposed Presentation on VR Space)
4. Third Embodiment of Present Technology (Notification Based on Person Recognition)
5. Fourth Embodiment of Present Technology (Superimposed Presentation of Avatar in VR Space)
6. Fifth Embodiment of Present Technology (Response Determination According to User Selection)
7. Sixth Embodiment of Present Technology (Response Determination by System)
8. Seventh Embodiment of Present Technology (Intervention and Obstacle Detection)
9. Eighth Embodiment of Present Technology (Sharing of VR Space)
10. Ninth Embodiment of Present Technology (Control According to Intervention Level)
11. Others

### 1. Overall System

### <System Configuration>

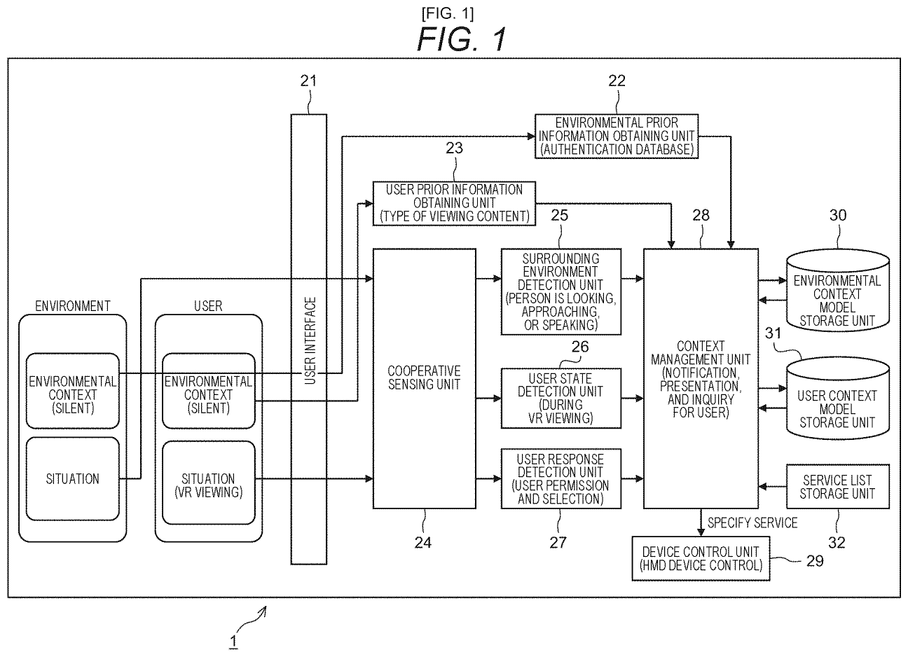

FIG. 1 is a diagram illustrating a configuration example of an ambient computing system according to an embodiment of the present technology.

An ambient computing system 1 of FIG. 1 is a system that detects information regarding a situation or a peripheral environment in which a user is present, that controls each of devices in accordance with the detected information and prior information, and that provides a service desired by the user.

While providing such a service, the ambient computing system 1 provides, as a function according to the present technology, for example, a service that detects human intervention for a user who is viewing VR content (hereinafter referred to as during VR viewing) and that controls an HMD and presents information in accordance with the detected human intervention.

The ambient computing system 1 includes a user interface 21, an environmental prior information obtaining unit 22, a user prior information obtaining unit 23, a cooperative sensing unit 24, a surrounding environment detection unit 25, a user state detection unit 26, a user response detection unit 27, a context management unit 28, a device control unit 29, an environmental context model storage unit 30, a user context model storage unit 31, and a service list storage unit 32.

Here, in the present specification, context is information including user information, environmental information, and a relationship between these pieces of information. Furthermore, a context model is a model used when the context management unit 28 is trained, and is also a model in which the context management unit 28 constructs a service personalized to the user (=a model of algorithm or machine learning).

The user interface 21 has interface functions for the user, such as giving a notification to the user and receiving an instruction from the user.

The ambient computing system 1 has two paths for obtaining information.

A first path is a path for obtaining prior information in advance on the basis of a user input. The first path is implemented by the environmental prior information obtaining unit 22 and the user prior information obtaining unit 23.

The environmental prior information obtaining unit 22 obtains prior information regarding an environment on the basis of a user input, and outputs the obtained environmental prior information to the context management unit 28 as environmental information.

As a function according to the present technology, in particular, the environmental prior information obtaining unit 22 outputs, for example, information regarding a recognition database for recognizing a face and voice of a person (hereinafter also referred to as an intervener) who intervenes to the context management unit 28 as environmental information.

The user prior information obtaining unit 23 obtains prior information regarding the user on the basis of a user input, and outputs the obtained user prior information to the context management unit 28 as user information.

As a function according to the present technology, in particular, the user prior information obtaining unit 23 outputs, for example, information indicating a type of viewing content viewed by the user to the context management unit 28 as user information.

A second path is a path for detecting current state information (in the case of the present technology, a state in which the user is viewing VR) regarding the environment and the user through a recognition device that performs sensing in cooperation with a plurality of sensing devices such as Internet of Things (IOT), that handles sensing information, and that is also capable of multimodal processing. The multimodal processing refers to processing of a plurality of types of information at a time. The second path is implemented by the cooperative sensing unit 24 as the recognition device, the surrounding environment detection unit 25, the user state detection unit 26, and the user response detection unit 27.

The cooperative sensing unit 24 obtains sensing information from the plurality of sensing devices, and performs predetermined signal processing for converting the obtained information into a format that is easy to handle in subsequent processing, such as removing a noise component or performing data cleansing for synchronizing data. The cooperative sensing unit 24 outputs the signal-processed information to a detection unit corresponding to the information among the surrounding environment detection unit 25, the user state detection unit 26, and the user response detection unit 27.

The surrounding environment detection unit 25 detects surrounding information such as an image, temperature, and sound from the information supplied from the cooperative sensing unit 24, and outputs information regarding the environment (hereinafter referred to as environmental information) obtained as a result of the detection to the context management unit 28.

As a function according to the present technology, the surrounding environment detection unit 25 detects human intervention such as viewing, approaching, talking, or the like by a person, and outputs environmental information obtained as a result to the context management unit 28.

The user state detection unit 26 detects information regarding the user from the information supplied from the cooperative sensing unit 24. For example, the user state detection unit 26 performs personal identification of the user by face recognition using an RGB image, detects an action of the user on the basis of information regarding skeleton detection and an environment map, and processes, in a multimodal manner, vital information such as an expression obtained from an RGB camera and a body temperature obtained from a wearable terminal to detect an emotion such as comfort and discomfort of the user.

The user state detection unit 26 outputs information regarding the user (hereinafter referred to as user information) obtained as a result of the detection to the context management unit 28.

As a function according to the present technology, in particular, the user state detection unit 26 detects, for example, that the user is viewing VR, and outputs user information obtained as a result to the context management unit 28.

The user response detection unit 27 detects a response of the user to the service provided by the context management unit 28 from the information supplied from the cooperative sensing unit 24, and outputs response information and feedback information regarding the user obtained as a result of the detection to the context management unit 28.

As a function according to the present technology, in particular, the user response detection unit 27 detects permission, selection, or the like by the user with respect to the service provided by the context management unit 28, such as notification, and outputs response information and feedback information regarding the user obtained as a result of the detection to the context management unit 28.

The context management unit 28 accumulates information supplied from the surrounding environment detection unit 25, the user state detection unit 26, and the user response detection unit 27, thereby learning, as an environmental context model, a model regarding the environment indicating particular environments in which particular regions are likely to be in particular time zones. The context management unit 28 stores the learned environmental context model in the environmental context model storage unit 30.

The context management unit 28 accumulates information supplied from the surrounding environment detection unit 25, the user state detection unit 26, and the user response detection unit 27, thereby learning, as a user context model, a model regarding habitual behavior patterns of the user indicating particular situations in which the user performs particular actions. The context management unit 28 stores the learned user context model in the user context model storage unit 31.

In a case where information indicating a similar situation is obtained after learning each context model, the context management unit 28 controls the device control unit 29 to provide a personalized service that preempts the user's action using the user context model from a device with which the ambient computing system 1 cooperates.

The context management unit 28 receives, via the user response detection unit 27, a response of the user at a time when the personalized service is provided to obtain feedback information indicating whether the service is actually appropriate, and relearns each context model to improve accuracy of the context model.

Furthermore, the context management unit 28 can model a code of behavior in which the user tends to select particular options in particular situations by accumulating learning of a context model of habitual behavior patterns, and it is possible to achieve a personalized service in advance for the user even if the user does not customarily perform some actions.

As a function according to the present technology, in particular, for example, the context management unit 28 controls the device control unit 29 in such a way as to provide personalized services for notification, presentation, inquiry and the like to the user from the HMD, which is one of devices with which the ambient computing system 1 cooperates.

Under the control of the context management unit 28, the device control unit 29 causes a device (in the case of the present technology, the HMD) with which the ambient computing system 1 cooperates to provide the personalized services.

The environmental context model storage unit 30 stores the environmental context model. In addition, the environmental context model storage unit 30 stores information used when learning the environmental context model and information including the relationship as environmental context.

The user context model storage unit 31 stores the user context model. In addition, the user context model storage unit 31 stores information used when learning the user context model and information including the relationship as user context.

The service list storage unit 32 stores a list of devices that perform services that can be provided for the user.

Details of the functions in the present technology in the ambient computing system 1 of FIG. 1 will be described hereinafter.

### 2. First Embodiment of Present Technology (Notification of Intervention Detection)

### <Outline of HMD System>

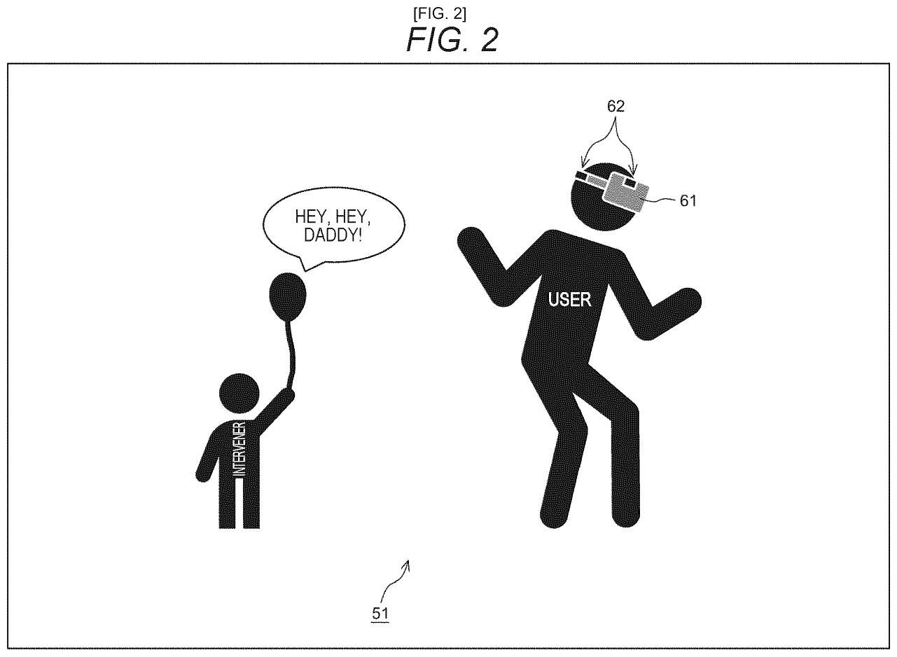

FIG. 2 is a diagram illustrating an outline of an HMD system according to the first embodiment of the present technology.

FIG. 2 illustrates a state of a user who uses an HMD system 51 having the functions in the present technology in the ambient computing system 1 of FIG. 1.

For example, another person (an intervener; a child in FIG. 2) speaks from the outside, “Hey, hey, daddy”, to the user wearing an HMD 61 and viewing VR.

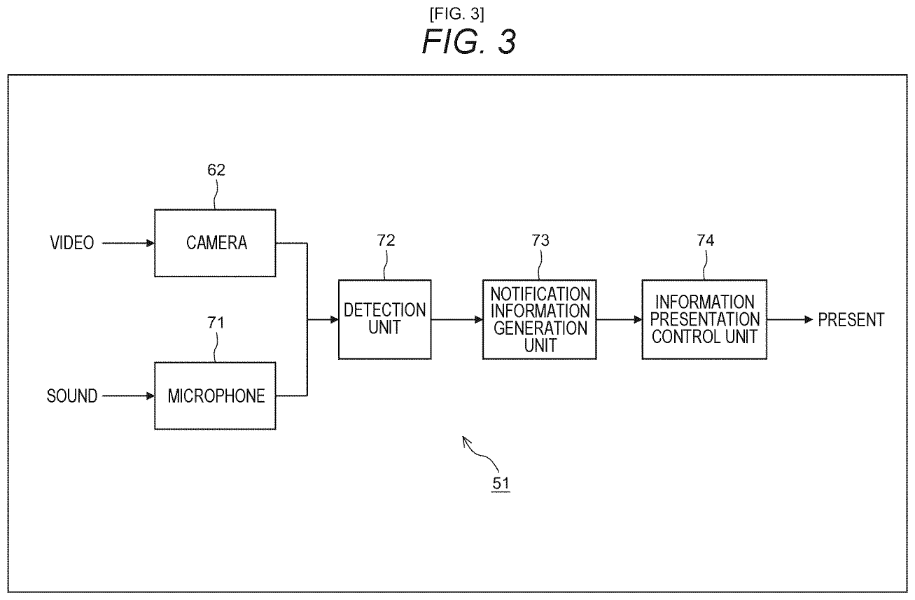

The HMD system 51 detects that the child is talking to the user with a camera 62 and a microphone 71 (FIG. 3 referred to as later) provided in the HMD 61, presents a result of the detection to the HMD 61, and notifies the user of the result of the detection.

As a result, even if the user is immersed in a VR space, the user can immediately notice that the child has spoken to the user.

### <Configuration of HMD System>

FIG. 3 is a block diagram illustrating a configuration example of the HMD system 51 in FIG. 2.

The HMD system 51 includes the camera 62 illustrated in FIG. 2, the microphone 71, a detection unit 72, a notification information generation unit 73, and an information presentation control unit 74.

Note that the camera 62, the microphone 71, and the detection unit 72 correspond to the cooperative sensing unit 24, the surrounding environment detection unit 25, the user state detection unit 26, and the user response detection unit 27 in FIG. 1. The notification information generation unit 73 corresponds to the context management unit 28 in FIG. 1. The information presentation control unit 74 corresponds to the device control unit 29 in FIG. 1.

The camera 62 is an imaging unit that images the surroundings, and is provided in the HMD 61 worn by the user. The camera 62 outputs video data generated by imaging the surroundings of the user to the detection unit 72.

The microphone 71 is a sound collection unit and is provided in the HMD 61 worn by the user. The microphone 71 outputs audio data generated by collecting sound around the user to the detection unit 72.

The detection unit 72 detects external human intervention (presence of an intervener) from the outside on the basis of the video data supplied from the camera 62 and the audio data supplied from the microphone 71, and supplies a result of the detection to the notification information generation unit 73. The human intervention includes, for example, intervention by voice when being spoken to by a person, intervention by a visual line when being seen by a person, intervention by action when being approached by a person, and the like.

The notification information generation unit 73 generates notification information for notifying of the result of the detection supplied from the detection unit 72, and outputs the generated notification information to the information presentation control unit 74.

The information presentation control unit 74 causes a presentation unit (not illustrated) included in the HMD 61 to present the notification information supplied from the notification information generation unit 73.

At this time, as means for the notification, it is conceivable to “display on a video watched by the user”, “notify by sound”, or the like, but any method may be used. Therefore, the notification information generated by the notification information generation unit 73 is video data in the case of video notification, and is audio data in the case of audio notification.

### [Configuration of Detection Unit]

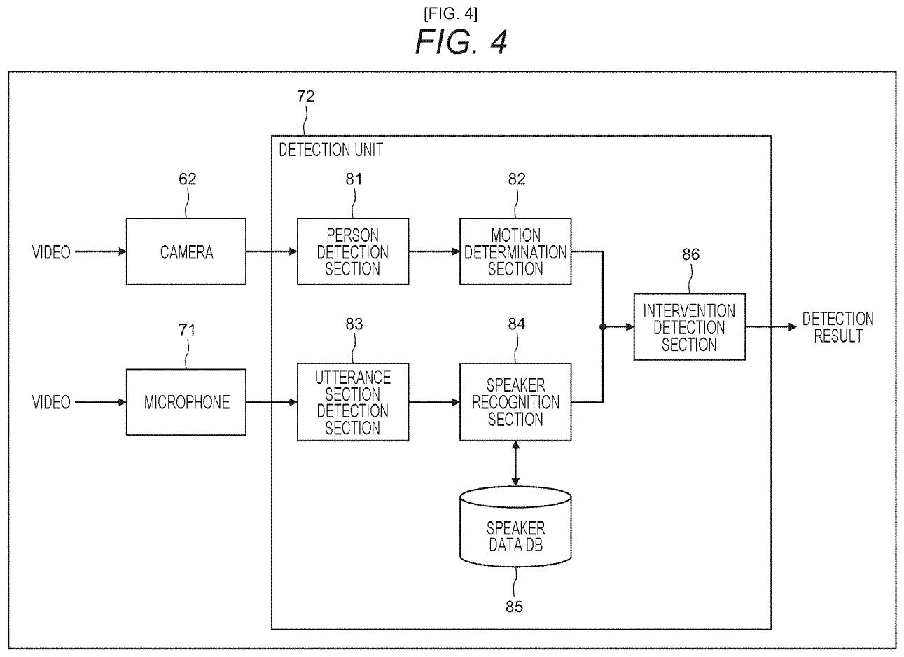

FIG. 4 is a block diagram illustrating a configuration example of the detection unit 72 in FIG. 3.

In FIG. 4, the detection unit 72 includes a person detection section 81, a motion determination section 82, an utterance section detection section 83, a speaker recognition section 84, a speaker data database (DB) 85, and an intervention detection section 86.

The person detection section 81 detects a person from video data supplied from the camera 62. The person detection section 81 outputs information regarding the detected person to the motion determination section 82.

The motion determination section 82 determines a face direction from the information regarding a person supplied from the person detection section 81, and outputs a result of the determination of the face direction to the intervention detection section 86. The motion determination section 82 also determines whether or not size of the person is becoming larger in the video from the information regarding a person supplied from the person detection section 81, and outputs a result of the determination whether the size of the person is becoming larger to the intervention detection section 86.

The utterance section detection section 83 detects an utterance section from the audio data supplied from the microphone 71. The utterance section detection section 83 outputs information indicating the detected utterance section to the speaker recognition section 84.

The speaker recognition section 84 determines whether a person who is speaking (hereinafter also referred to as a speaker) is a person other than the user on the basis of the audio data in the utterance section indicated by the information supplied from the utterance section detection section 83 and speaker data registered in the speaker data DB 85. The speaker recognition section 84 outputs information regarding the determined speaker to the intervention detection section 86.

On the basis of the result of the determination of the face direction supplied from the motion determination section 82, the speaker information supplied from the speaker recognition section 84, and the like, the intervention detection section 86 detects human intervention such as a person speaking to the user, a person looking at the user, or a person approaching the user. The intervention detection section 86 outputs a result of the detection of human intervention to the notification information generation unit 73.

### <Process by HMD System>

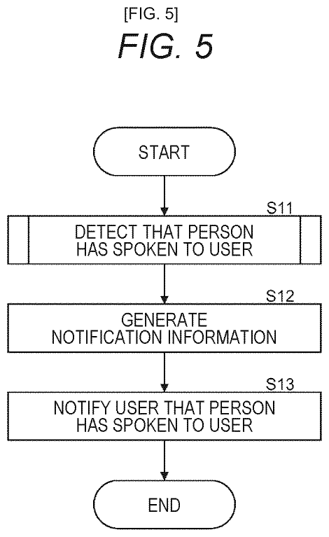

FIG. 5 is a flowchart illustrating a process by the HMD system 51 in FIG. 2. The process of FIG. 5 is performed for each frame or for each frame at predetermined intervals. Note that other processes by the HMD system described later are also performed for each frame or each frame at the predetermined intervals.

For example, a child speaks, “Hey, hey, daddy”, to the user wearing the HMD 61 and viewing VR.

In step S11, the camera 62, the microphone 71, and the detection unit 72 detect that a person has spoken to the user.

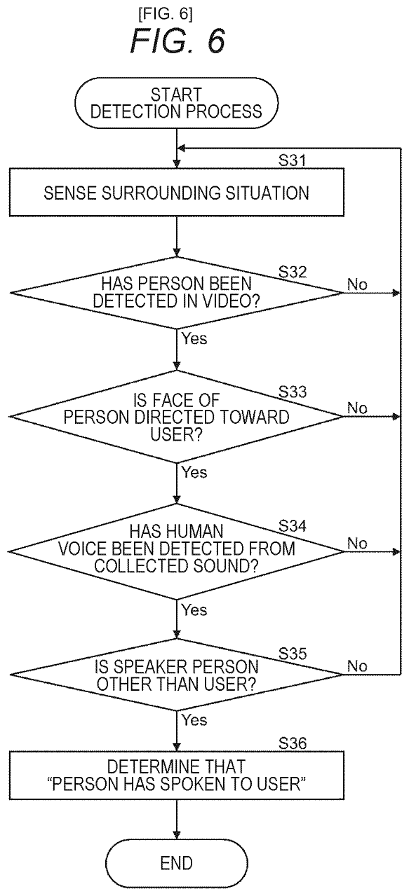

That is, the camera 62 and the microphone 71 provided in the HMD 61 sense a situation around the user, and output video data and audio data to the detection unit 72, respectively. The detection unit 72 detects that a person has spoken to the user on the basis of the video data supplied from the camera 62 and the audio data supplied from the microphone 71, and supplies a result of the detection to the notification information generation unit 73. Note that details of a detection process in step S11 will be described later with reference to FIG. 6.

In step S12, the notification information generation unit 73 generates notification information for notifying the user that a person has spoken to the user, which is the result of the detection supplied from the detection unit 72, and outputs the generated notification information to the information presentation control unit 74.

In step S13, the information presentation control unit 74 causes the presentation unit included in the HMD 61 to display the notification information supplied from the notification information generation unit 73, thereby notifying the user that a person has spoken to the user. The process then ends.

### <Detection Process>

FIG. 6 is a flowchart illustrating details of the detection process in step S11 in FIG. 5.

In step S31, the camera 52 and the microphone 71 sense a surrounding situation. The camera 62 outputs video data generated by imaging the surroundings of the user to the detection unit 72. The microphone 71 outputs audio data generated by collecting sound around the user to the detection unit 72.

In step S32, the person detection section 81 determines whether or not a person has been detected in a video indicated by the video data supplied from the camera 62. In a case where it is determined in step S32 that a person has not been detected in the video, the process returns to step S31, and subsequent processing is repeated.

In a case where it is determined in step S32 that a person has been detected in the video, the process proceeds to step S33.

In step S33, the motion determination section 82 determines whether or not a face of the person in the video is directed toward the user from information regarding the person supplied from the person detection section 81. In a case where it is determined in step S33 that the person's face is not directed toward the user, the process returns to step S31, and the subsequent processing is repeated.

In a case where it is determined in step S33 that the person's face is directed toward the user, the process proceeds to step S34.

The utterance section detection section 83 detects an utterance section from collected sound on the basis of audio data supplied from the microphone 71.

In step S34, the utterance section detection section 83 determines whether or not human voice has been detected from the collected sound on the basis of the audio data supplied from the microphone 71. In a case where it is determined in step S34 that human voice has not been detected from the collected sound, the process returns to step S31, and the subsequent processing is repeated.

In a case where it is determined in step S34 that human voice has been detected from the collected sound, the process proceeds to step S35.

In step S35, the speaker recognition section 84 determines whether a speaker is a person other than the user on the basis of audio data in an utterance section indicated by information supplied from the utterance section detection section 83 and the speaker data registered in the speaker data DB 85. In a case where it is determined that the speaker is the user, the process returns to step S31, and the subsequent processing is repeated.

In a case where it is determined in step S35 that the speaker is a person other than the user, the process proceeds to step S36.

In step S36, the intervention detection section 86 determines that “a person has spoken”, and outputs a result of the detection indicating that it has been detected that a person has spoken. The process then returns to step S11 in FIG. 5.

Note that although an example in which sensing is performed by the camera 62 and the microphone 71 provided in the HMD 61 has been described in the above description, sensing may be performed by an external camera and an external microphone in a case where VR is viewed at a specific place.

### <Modification of HMD System>

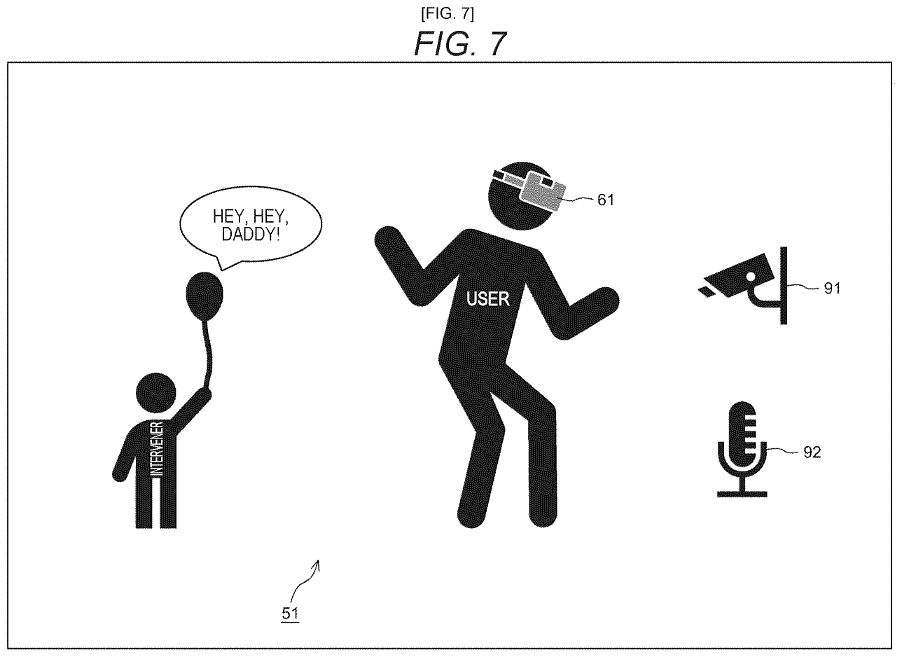

FIG. 7 is a diagram illustrating a modification of the HMD system in FIG. 2.

FIG. 7 illustrates an example in which a child speaks to the user who is viewing VR using the HMD system 51 in a specific place such as a room.

The HMD system 51 in FIG. 7 is different from the HMD system 51 in FIG. 2 in that the camera 62 and the microphone 71 are replaced with a camera 91 and a microphone 92.

The camera 91 and the microphone 92 are provided outside, for example, in the room or the like, instead of in the HMD 61.

That is, the camera 91 is different only in terms of an installation position, and is configured similarly to the camera 62 in other respects. The microphone 92 is different only in terms of an installation position, and is configured similarly to the microphone 71 in other respects.

As described above, in a case where the user always views VR at a certain place, the external camera 91 and the microphone 92 may perform the sensing.

Note that although an example of detecting that a person has spoken to the user has been described with reference to FIG. 5, it is also possible to detect that a person is looking at or approaching the user.

### <Another Process by HMD System>

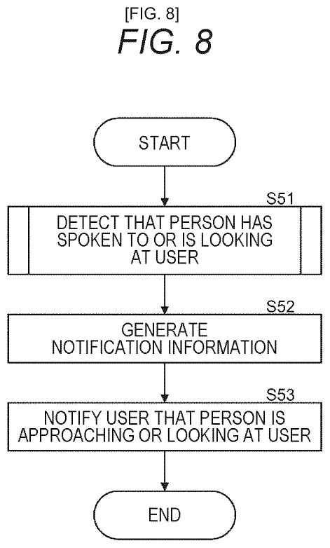

FIG. 8 is a flowchart illustrating another process by the HMD system 51 in FIG. 2.

For example, a person is approaching or looking at the user wearing the HMD 61 and viewing VR.

In step S51, the camera 62, the microphone 71, and the detection unit 72 detect that a person is approaching or looking at the user.

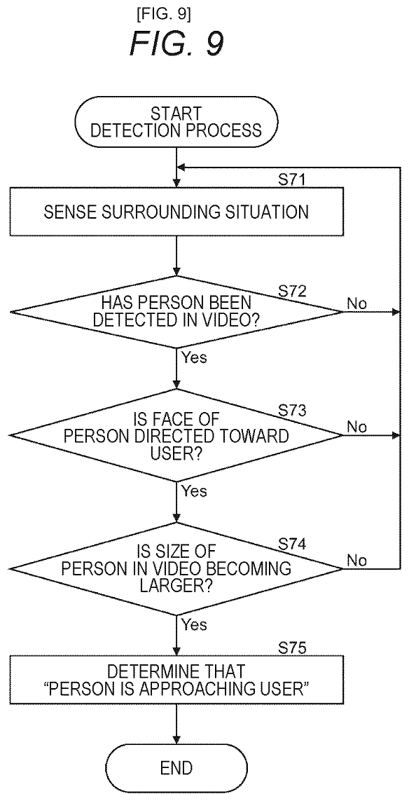

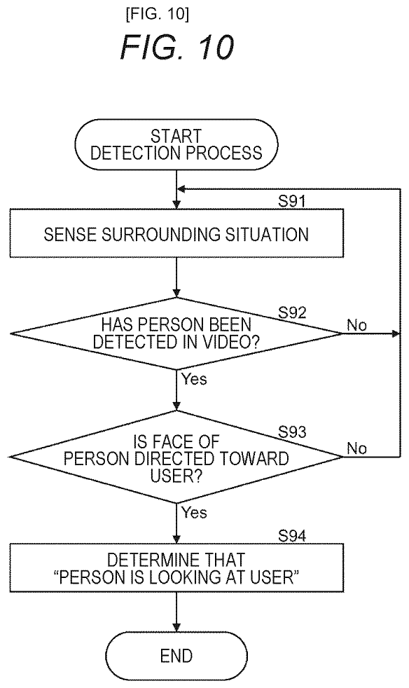

That is, the camera 62 and the microphone 71 provided in the HMD 61 sense a situation around the user, and output video data and audio data to the detection unit 72, respectively. The detection unit 72 detects that a person is approaching or looking at the user on the basis of the video data supplied from the camera 62 and the audio data supplied from the microphone 71, and supplies a result of the detection to the notification information generation unit 73. Note that details of a detection process in step S51 will be described later with reference to FIGS. 9 and 10.

In step S52, the notification information generation unit 73 generates notification information for notifying the user that a person is approaching or looking at the user, which is the result of the detection supplied from the detection unit 72, and outputs the generated notification information to the information presentation control unit 74.

In step S53, the information presentation control unit 74 causes the presentation unit included in the HMD 61 to display the notification information supplied from the notification information generation unit 73, thereby notifying the user that a person is approaching or looking at the user. The process then ends.

### <Detection Process>

FIG. 9 is a flowchart illustrating details of the detection process in step S51 in FIG. 8.

FIG. 9 illustrates a process for detecting that a person is approaching the user.

In step S71, the camera 62 and the microphone 71 sense a surrounding situation. The camera 62 outputs video data generated by imaging the surroundings of the user to the detection unit 72. The microphone 71 outputs audio data generated by collecting sound around the user to the detection unit 72.

In step S72, the person detection section 81 determines whether or not a person has been detected in a video indicated by the video data supplied from the camera 62. In a case where it is determined in step S72 that a person has not been detected in the video, the process returns to step S71, and subsequent processing is repeated.

In a case where it is determined in step S72 that a person has been detected in the video, the process proceeds to step S73.

In step S73, the motion determination section 82 determines whether or not a face of the person is directed toward the user from information regarding the person supplied from the person detection section 81. In a case where it is determined in step S73 that the face of the person is not directed toward the user from the information regarding the person, the process returns to step S71, and the subsequent processing is repeated.

In a case where it is determined in step S73 that the person's face is directed toward the user, the process proceeds to step S74.

In step S74, the motion determination section 82 determines whether or not the size of the person in the video is becoming larger from information regarding the person supplied from the person detection section 81. In a case where it is determined in step S74 that the size of the person in the video is not becoming larger, the process returns to step S71, and the subsequent processing is repeated.

In a case where it is determined in step S74 that the size of the person in the video is becoming larger, the process proceeds to step S75.

In step S75, the intervention detection section 86 determines that “a person is approaching”, and outputs a result of the detection indicating that it has been detected that a person is approaching. The process then returns to step S51 in FIG. 8.

### <Detection Process>

FIG. 10 is a flowchart illustrating another example of the detection process in step S51 in FIG. 8.

FIG. 10 illustrates a process for detecting that a person is looking at the user.

In step S91, the camera 52 and the microphone 71 sense a surrounding situation. The camera 62 outputs video data generated by imaging the surroundings of the user to the detection unit 72. The microphone 71 outputs audio data generated by collecting sound around the user to the detection unit 72.

In step S92, the person detection section 81 determines whether or not a person has been detected in a video indicated by the video data supplied from the camera 62. In a case where it is determined in step S92 that a person has not been detected in the video, the process returns to step S91, and subsequent processing is repeated.

In a case where it is determined in step S92 that a person has been detected in the video, the process proceeds to step S93.

In step S93, the motion determination section 82 determines whether or not a face of the person is directed toward the user from information regarding the person supplied from the person detection section 81. In a case where it is determined in step S93 that the face of the person is not directed toward the user from the information regarding the person, the process returns to step S91, and the subsequent processing is repeated.

In a case where it is determined in step S93 that the person's face is directed toward the user, the process proceeds to step S94.

In step S94, the intervention detection section 86 determines that “a person is looking this way”, and outputs a result of the detection indicating that it has been detected that a person is looking this way. The process then returns to step S51 in FIG. 8.

Note that since audio data is not used in FIGS. 9 and 10, the HMD system 51 may have a configuration without the microphone 71.

### 3. Second Embodiment of Present Technology (Superimposed Presentation on VR Space)

### <Outline of HMD System>

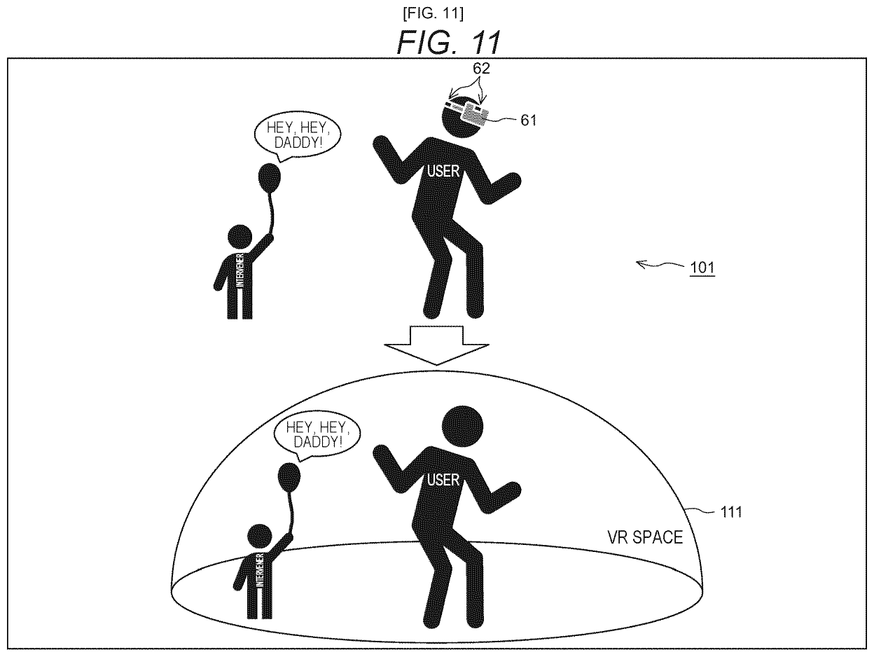

FIG. 11 is a diagram illustrating an outline of an HMD system according to a second embodiment of the present technology.

FIG. 11 illustrates a state of a user who uses an HMD system 101 having the functions in the present technology in the ambient computing system 1 of FIG. 1.

For example, another person (an intervener; a child in FIG. 11) speaks from the outside, “Hey, hey, daddy”, to the user wearing the HMD 61 and viewing VR.

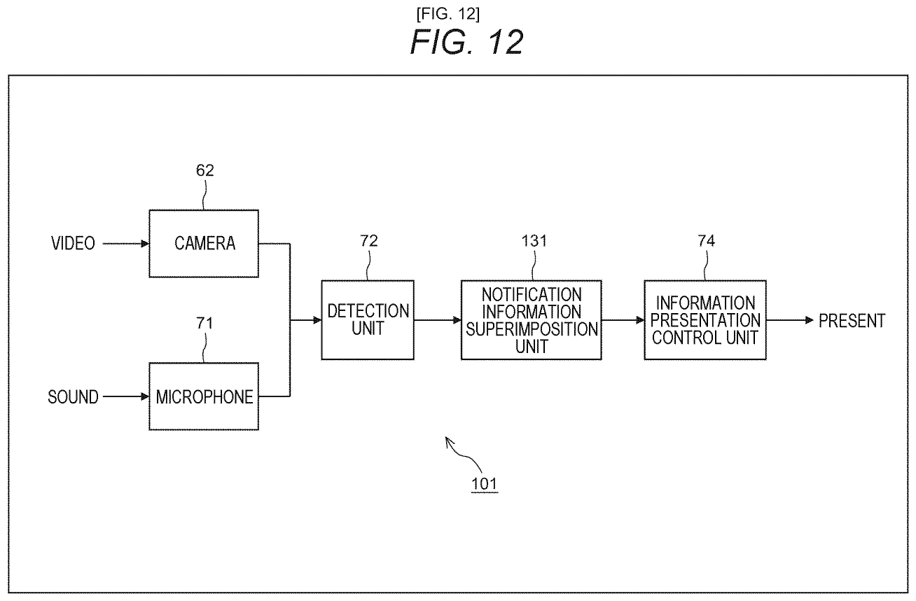

The HMD system 101 not only detects that the child has spoken to the user with the camera 62 and the microphone 71 (FIG. 12) provided in the HMD 61 and notifies the user of a result of the detection, but also projects obtained video data and audio data to a VR space 111 displayed on the presentation unit of the HMD 61 to present the video data and the audio data in the VR space 111.

As described above, in the HMD system 101 in FIG. 11, a video and a voice of a person who has spoken to the user are superimposed and presented on data regarding the VR space 111 viewed by the user. As a result, the user can continuously interact with the person who has spoken thereto without leaving the VR space 111.

### <Configuration of HMD System>

FIG. 12 is a block diagram illustrating a configuration example of the HMD system 101 in FIG. 11.

The HMD system 101 is different from the HMD system 51 of FIG. 3 in that the notification information generation unit 73 is replaced with a notification information superimposition unit 131. Note that the notification information superimposition unit 131 corresponds to the context management unit 28 in FIG. 1.

The detection unit 72 supplies the video data supplied from the camera 62, the audio data supplied from the microphone 71, and a result of detection of intervention to the notification information superimposition unit 131.

The notification information superimposition unit 131 superimposes video data regarding an intervener upon the video data regarding the VR space 111 on the basis of the video data, the audio data, and the result of detection supplied from the detection unit 72, superimposes (synthesizes) the audio data upon the audio data regarding the VR space 111, and outputs the superimposed data (referred to as superimposition data) to the information presentation control unit 74. Note that the notification information superimposition unit 131 may generate notification information for notifying of the result of detection of intervention supplied from the detection unit 72, and also superimpose the generated notification information upon the data regarding the VR space 111.

The information presentation control unit 74 displays the superimposed data supplied from the notification information superimposition unit 131 in the VR space 111 of the presentation unit included in the HMD 61.

### <Process by HMD System>

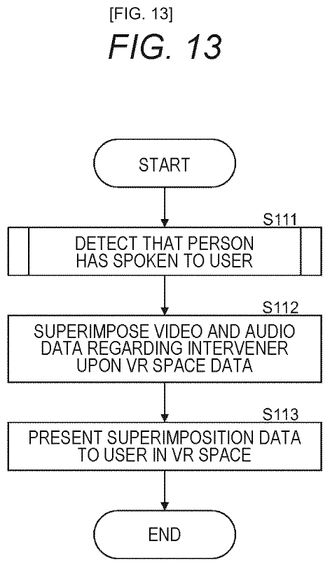

FIG. 13 is a flowchart illustrating a process by the HMD system 101 in FIG. 11.

For example, a child speaks, “Hey, hey, daddy”, to the user wearing the HMD 61 and viewing VR.

In step S111, the camera 62, the microphone 71, and the detection unit 72 detect that a person has spoken to the user as described above with reference to FIG. 6.

That is, the camera 62 and the microphone 71 provided in the HMD 61 sense a situation around the user, and output video data and audio data to the detection unit 72, respectively. The detection unit 72 detects that a person has spoken to the user on the basis of the video data supplied from the camera 62 and the audio data supplied from the microphone 71, and supplies the video data, the audio data, and a result of the detection to the notification information superimposition unit 131.

In step S112, the notification information superimposition unit 131 superimposes the video data and the audio data regarding the intervener upon data regarding the VR space 111 on the basis of the result of the detection supplied from the detection unit 72, and outputs superimposition data to the information presentation control unit 74.

In step S113, the information presentation control unit 74 causes the presentation unit included in the HMD 61 to present, in the VR space 111, the superimposition data supplied from the notification information superimposition unit 131, thereby notifying the user that a person has spoken to the user. The process then ends.

### 4. Third Embodiment of Present Technology (Notification Based on Person Recognition)

### <Configuration of HMD System>

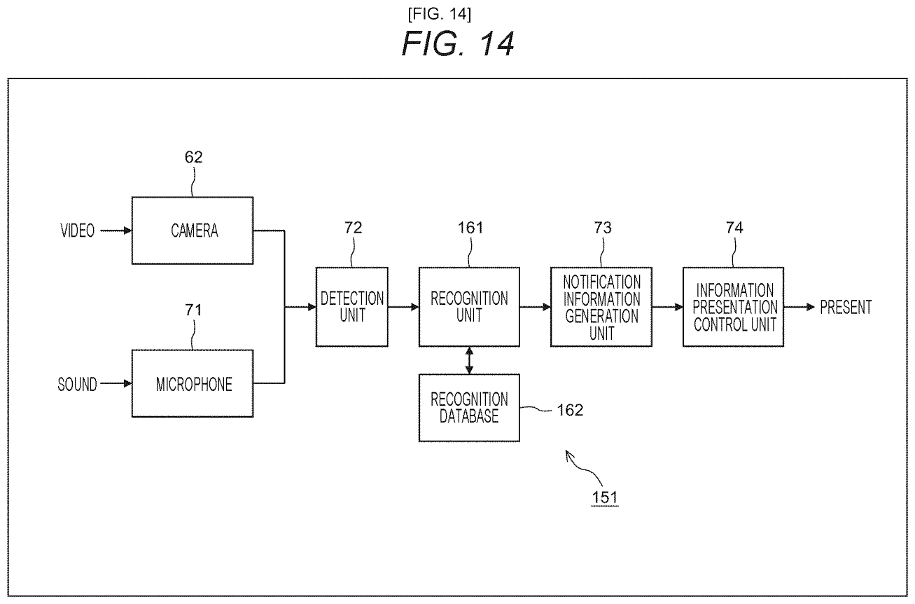

FIG. 14 is a block diagram illustrating a configuration example of an HMD system according to a third embodiment of the present technology.

FIG. 14 illustrates a configuration example of an HMD system 151 having the functions in the present technology in the ambient computing system 1 of FIG. 1.

The HMD system 151 of FIG. 14 is different from the HMD system 51 of FIG. 3 in that a recognition unit 161 and a recognition database 162 are added. Note that the recognition unit 161 and the recognition database 162 correspond to the context management unit 28 in FIG. 1.

The detection unit 72 supplies the video data supplied from the camera 62, the audio data supplied from the microphone 71, and a result of detection of intervention to the recognition unit 161.

By using information registered in the recognition database 162, the recognition unit 161 refers to the result of the detection of intervention supplied from the detection unit 72, and recognizes from the video data who is the person speaking to the user.

Note that a method for recognizing who the person is may be face recognition using video data or voice recognition using voice. In either case, the recognition unit 161 performs the recognition by, for example, referring to the recognition database 162 in which user information for recognizing persons' faces and voices is registered in advance, and returning an ID of a person if the person is included in the recognition database, or an inconclusive result if the person is not included.

The recognition unit 161 outputs the video data and the audio data supplied from the detection unit 72 and the result of the recognition of the person to the notification information generation unit 73.

In the recognition database 162, user information for recognizing persons' faces and voices is registered in advance.

The notification information generation unit 73 generates notification information for notifying of the result of the recognition supplied from the recognition unit 161, and outputs the generated notification information to the information presentation control unit 74.

### 5. Fourth Embodiment of Present Technology (Superimposed Presentation of Avatar in VR Space)

### <Outline of HMD System>

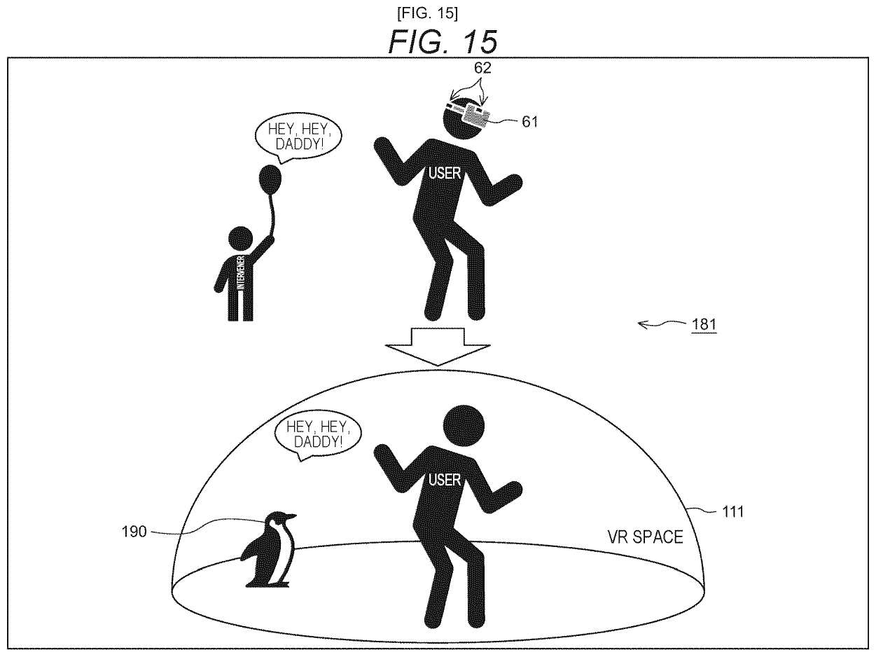

FIG. 15 is a diagram illustrating an outline of an HMD system according to a fourth embodiment of the present technology.

FIG. 15 illustrates a state of a user who uses an HMD system 181 having the functions in the present technology in the ambient computing system 1 of FIG. 1.

For example, another person (an intervener; a child in FIG. 15) speaks from the outside, “Hey, hey, daddy”, to the user wearing the HMD 61 and viewing VR.

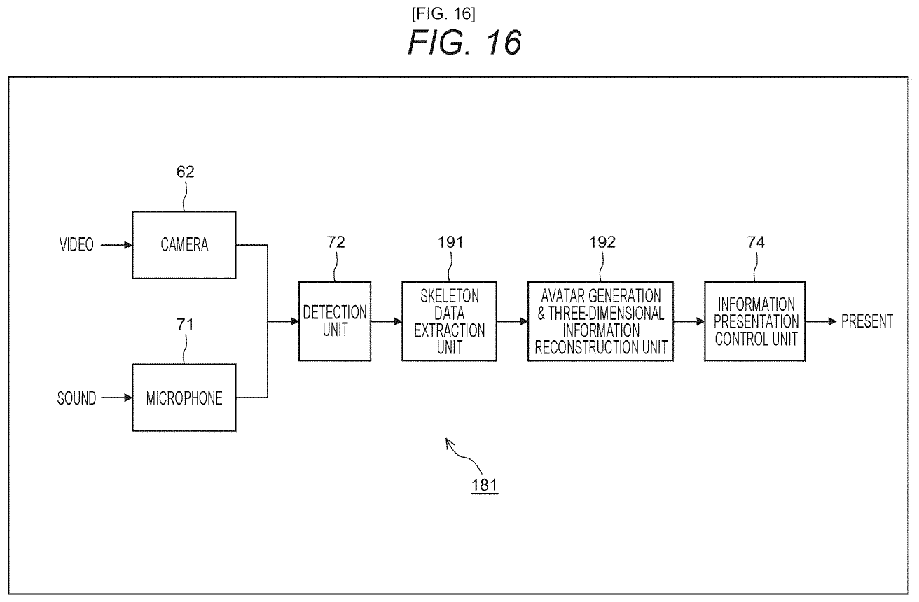

The HMD system 181 not only detects that the child has spoken to the user with the camera 62 and the microphone 71 (FIG. 16) provided in the HMD 61 and notifies the user of a result of the detection, but also generates an avatar 190 from the obtained video data and present the generated avatar 190 in the VR space 111.

In contrast to the HMD system 101 in FIG. 11 in which a video and a voice of a person who has spoken to the user are superimposed and presented on the data regarding the VR space 111 viewed by the user, in the HMD system 181 in FIG. 15, the avatar 190 generated from a video of a person speaking to the user is superimposed and presented on the data regarding the VR space 111 viewed by the user.

### <Configuration of HMD System>

FIG. 16 is a block diagram illustrating a configuration example of the HMD system 181 in FIG. 15.

The HMD system 181 is different from the HMD system 51 in FIG. 3 in that a skeleton data extraction unit 191 is added and that the notification information generation unit 73 is replaced with an avatar generation & three-dimensional information reconstruction unit 192. Note that the skeleton data extraction unit 191 and the avatar generation & three-dimensional information reconstruction unit 192 correspond to the context management unit 28 in FIG. 1.

The detection unit 72 supplies the video data supplied from the camera 62, the audio data supplied from the microphone 71, and a result of detection of intervention to the skeleton data extraction unit 191.

The skeleton data extraction unit 191 extracts human skeleton data from the video data supplied from the detection unit 72, and outputs the video data, the audio data, and the skeleton data to the avatar generation & three-dimensional information reconstruction unit 192.

The avatar generation & three-dimensional information reconstruction unit 192 generates the avatar 190 on the basis of the skeleton data from the skeleton data extraction unit 191, reconstructs the avatar 190 as three-dimensional information, superimposes the avatar 190 upon the data regarding the VR space 111, and outputs resultant superimposition data to the information presentation control unit 74.

The information presentation control unit 74 causes the presentation unit included in the HMD 61 to display the superimposition data supplied from the avatar generation & three-dimensional information reconstruction unit 192.

### 6. Fifth Embodiment of Present Technology (Response Determination According to User Selection)

### <Configuration of HMD System>

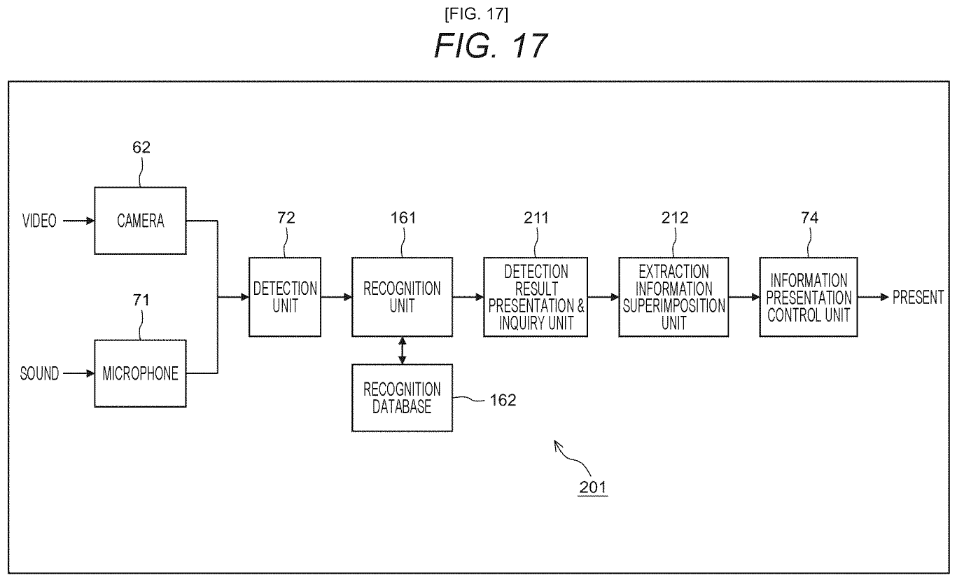

FIG. 17 is a block diagram illustrating a configuration example of an HMD system according to a fifth embodiment of the present technology.

FIG. 17 illustrates a configuration example of an HMD system 201 having the functions in the present technology in the ambient computing system 1 of FIG. 1.

The HMD system 201 of FIG. 17 is different from the HMD system 151 of FIG. 14 in that a detection result presentation inquiry unit 211 is added and that the notification information generation unit 73 is replaced with an extraction information superimposition unit 212. Note that the detection result presentation & inquiry unit 211 and the extraction information superimposition unit 212 correspond to the context management unit 28 in FIG. 1.

That is, the HMD system 201 of FIG. 17 notifies the user of detection of an intervener, inquires of the user about a response to the intervener, and determines whether or not to respond to the intervener in accordance with selection by the user.

The recognition unit 161 outputs the video data and the audio data supplied from the detection unit 72 and a result of recognition of a person to the detection result presentation & inquiry unit 211. Note that in a case where the recognition is not performed, the recognition unit 161 outputs the video data and the audio data supplied from the detection unit 72 and a result of detection of intervention to the detection result presentation & inquiry unit 211.

The detection result presentation & inquiry unit 211 generates notification information for notifying of a result of recognition of a person supplied from the recognition unit 161, and causes the presentation unit included in the HMD 61 to present the generated notification information and an inquiry as to whether or not to display a person speaking to the user in the VR space.

The detection result presentation & inquiry unit 211 receives selection (approval or disapproval) by the user via an operation unit (not illustrated) or the like. In a case where the user approves, the detection result presentation & inquiry unit 211 outputs the video data and the audio data supplied from the detection unit 72 and a result of recognition of a person (or a result of detection of intervention) to the extraction information superimposition unit 212.

The extraction information superimposition unit 212 extracts video and audio data regarding the intervener from the video data and the audio data supplied from the detection result presentation & inquiry unit 211. The extraction information superimposition unit 212 superimposes the extracted video and audio data regarding the intervener upon the data regarding the VR space 111, and outputs superimposition data to the information presentation control unit 74.

### <Process by HMD System>

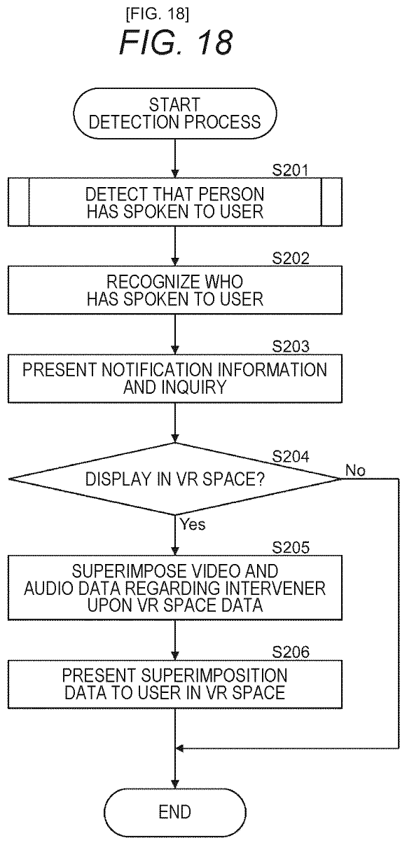

FIG. 18 is a flowchart illustrating a process by the HMD system 201 of FIG. 17.

For example, a child speaks, “Hey, hey, daddy”, to the user wearing the HMD 61 and viewing VR.

In step S201, the camera 62, the microphone 71, and the detection unit 72 detect that a person has spoken to the user as described above with reference to FIG. 6.

In step S202, by using the information registered in the recognition database 162, the recognition unit 161 refers to a result of detection of intervention supplied from the detection unit 72, and recognizes from video data who is the person speaking to the user.

In step S203, the detection result presentation & inquiry unit 211 generates notification information for notifying of a result of recognition of a person supplied from the recognition unit 161, and causes the presentation unit included in the HMD 61 to present the generated notification information and an inquiry as to whether or not to display the person who has spoken to the user in the VR space.

For example, a question, “Q has spoken to you. Display in the VR space?”, is presented, and the user selects yes or no.

In step S204, the detection result presentation & inquiry unit 211 determines whether or not to display the intervener in the VR space in accordance with the selection by the user. In a case where it is determined in step S204 that the intervener is not to be displayed in the VR space, the process by the HMD system 201 in FIG. 17 ends.

In a case where it is determined in step S204 that the intervener is to be displayed in the VR space, the process proceeds to step S205. At this time, the detection result presentation & inquiry unit 211 outputs the video data, the audio data, and the result of recognition of a person supplied from the recognition unit 161 to the extraction information superimposition unit 212.

In step S205, the extraction information superimposition unit 212 extracts video and audio data regarding the intervener from the video data and the audio data supplied from the detection result presentation & inquiry unit 211, superimposes the extracted video and audio data regarding the intervener upon the data regarding the VR space 111, and outputs superimposition data to the information presentation control unit 74.

In step S206, the information presentation control unit 74 causes the presentation unit included in the HMD 61 to present, in the VR space 111, the superimposition data supplied from the extraction information superimposition unit 212, thereby presenting a video and a voice of the intervener to the user. The process then ends.

As a result, the user can continuously interact with the person who has spoken thereto without leaving the VR space.

### <Example of Communication>

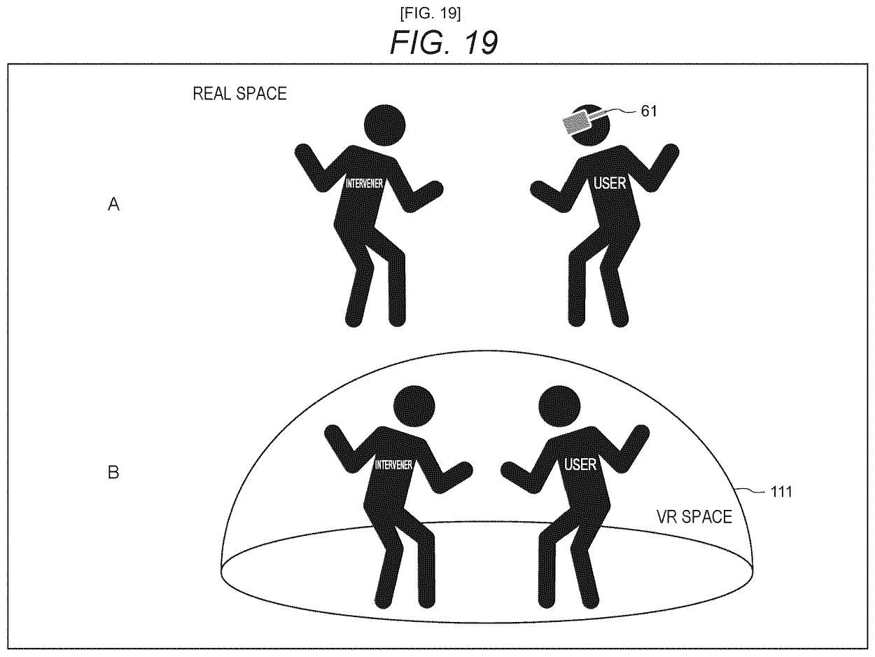

FIG. 19 is a diagram illustrating communication between the user and an intervener.

A of FIG. 19 illustrates communication in “real” as viewed from the intervener who has spoken to the user.

The intervener who has spoken to the user has a conversation in real space with the user wearing the HMD 61.

B of FIG. 19 illustrates communication in “virtual” as viewed from the user who has been spoken to.

The user who has been spoken to has a conversation with the intervener projected in the VR space 111.

### <Example of Presentation Method>

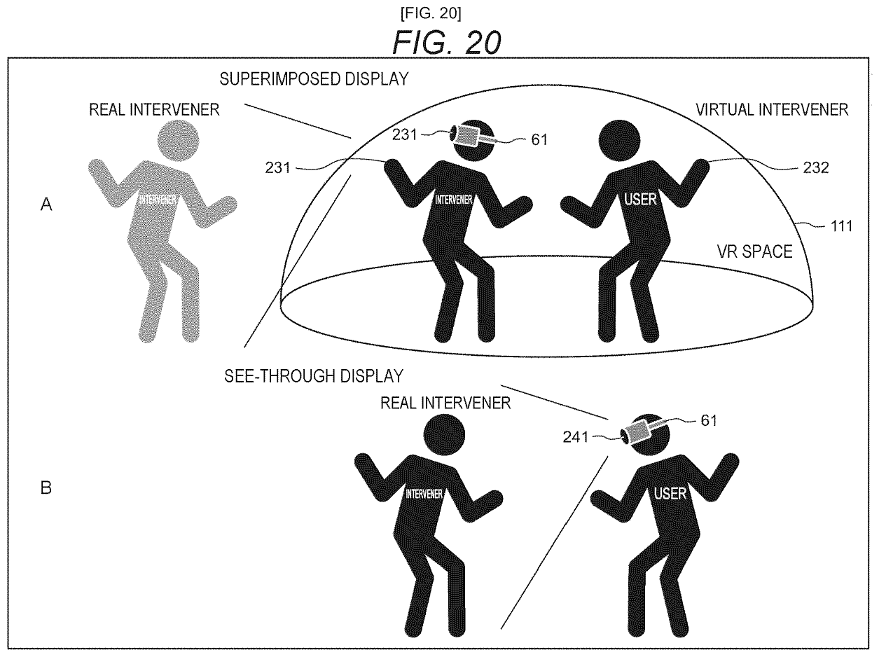

FIG. 20 is a diagram illustrating a display method in a case where a video of an intervener is presented to the user.

In FIG. 20, two display methods are illustrated.

As illustrated in A of FIG. 20, the HMD system 201 reconstructs a virtual image (avatar) 232 of the intervener captured by an omnidirectional camera 231 provided in the HMD 61 as three-dimensional information, and superimposes and displays the virtual image 232 in the VR space 111 where the user is.

In this case, the virtual image 232 of the intervener can be provided in the VR space 111 regardless of a position of the intervener.

As illustrated in B of FIG. 20, the HMD system 201 performs see-through display of the video of the intervener captured by a front camera 241 provided in the HMD 61. In the see-through display, for example, the VR space 111 is displayed with a transmittance of 50%, and the video of the intervener is displayed with a transmittance of 50%.

In this case, the user can see the intervener in the real space at an actual position in the real space while being in the VR space 111.

### <Another Process by HMD System>

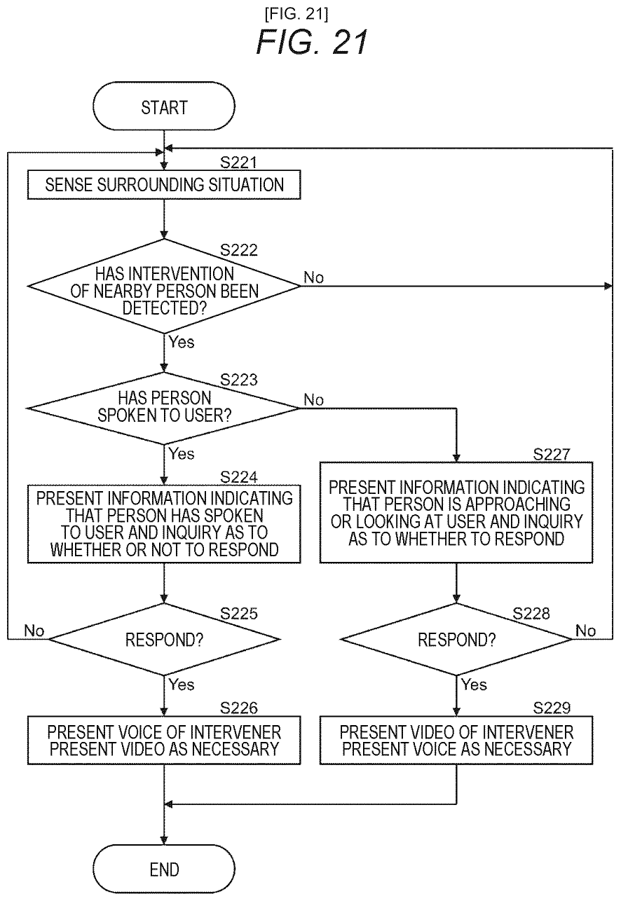

FIG. 21 is a flowchart illustrating another process by the HMD system 201 in FIG. 17.

In step S221, the camera 52 and the microphone 71 sense a surrounding situation.

In step S222, the detection unit 72 determines whether or not intervention by a nearby person (talking, watching, or approaching) has been detected on the basis of the video data supplied from the camera 62. In a case where it is determined in step S222 that intervention by a nearby person has not been detected, the process returns to step S221, and subsequent processing is repeated.

In a case where it is determined in step S222 that intervention by a nearby person has been detected, the process proceeds to step S223.

In step S223, the detection unit 72 determines whether or not a person has spoken to the user. In a case where it is determined in step S223 that a person has spoken to the user, the process proceeds to step S224.

In step S224, the detection result presentation & inquiry unit 211 generates notification information for notifying of a result of the detection (that a person has spoken to the user) supplied from the detection unit 72 via the recognition unit 161 and an inquiry as to whether or not to respond to the intervener (the person who has spoken to the user), and causes the presentation unit of the HMD 61 to present the inquiry.

In step S225, the detection result presentation & inquiry unit 211 determines whether or not to respond to the intervener in accordance with the selection by the user with respect to the presentation. In a case where it is determined in step S225 not to respond to the intervener, the process returns to step S221, and subsequent processing is repeated.

In a case where it is determined in step S225 that the intervener is to be responded to, the process proceeds to step S226.

In step S226, the extraction information superimposition unit 212 extracts a voice of the intervener from the audio data, and, for example, the information presentation unit 74 presents the voice to (the VR space of) the presentation unit. Note that a video of the intervener may also be presented as necessary. The process then ends.

In a case where it is determined in step S223 that a person has not spoken to the user, that is, in a case where it is determined in step S223 that a person is looking at or approaching the user, on the other hand, the process proceeds to step S227.

In step S227, the detection result presentation & inquiry unit 211 generates notification information for notifying of a result of the detection (that a person is looking at or approaching the user) supplied from the detection unit 72 via the recognition unit 161 and an inquiry as to whether or not to respond to the intervener (the person who is looking at or approaching the user), and causes the presentation unit of the HMD 61 to present the notification information and the inquiry.

In step S228, the detection result presentation & inquiry unit 211 determines whether or not to respond to the intervener in accordance with the selection by the user with respect to the presentation. In a case where it is determined in step S228 that the intervener is not to be responded to, the process returns to step S221, and the subsequent processing is repeated.

In a case where it is determined in step S228 that the intervener is to be responded to, the process proceeds to step S229.

In step S229, the extraction information superimposition unit 212 extracts the video of the intervener from the video data, and, for example, the information presentation unit 74 presents the video to (the VR space of) the presentation unit. Note that the voice of the intervener may also be presented as necessary. The process then ends.

Note that a timing to notify the user may be changed depending on a state of the intervener (speaking, looking at, or approaching).

For example, in a case where a person speaks to the user, the user is notified at a timing when the person speaks to the user.

In this case, for example, the voice obtained by the microphone 71 is reproduced as it is in the HMD 61. In doing so, the user can continue the conversation with the person who has spoken thereto without removing the HMD 61. Furthermore, in some cases, the video of the person who has spoken to the user may be presented.

In a case where a person is approaching or looking at the user, on the other hand, the user is notified at a timing of the approach or the looking.

In this case, for example, the video obtained by the camera 62 is reproduced as it is in the HMD 61. In this way, the user can recognize the intervener (the person approaching or looking at the user) without removing the HMD 61. In addition, in a case where the intervener utters, a voice of the intervener may be reproduced in the HMD 61.

### 7. Sixth Embodiment of Present Technology (Response Determination by System)

### <Configuration of HMD System>

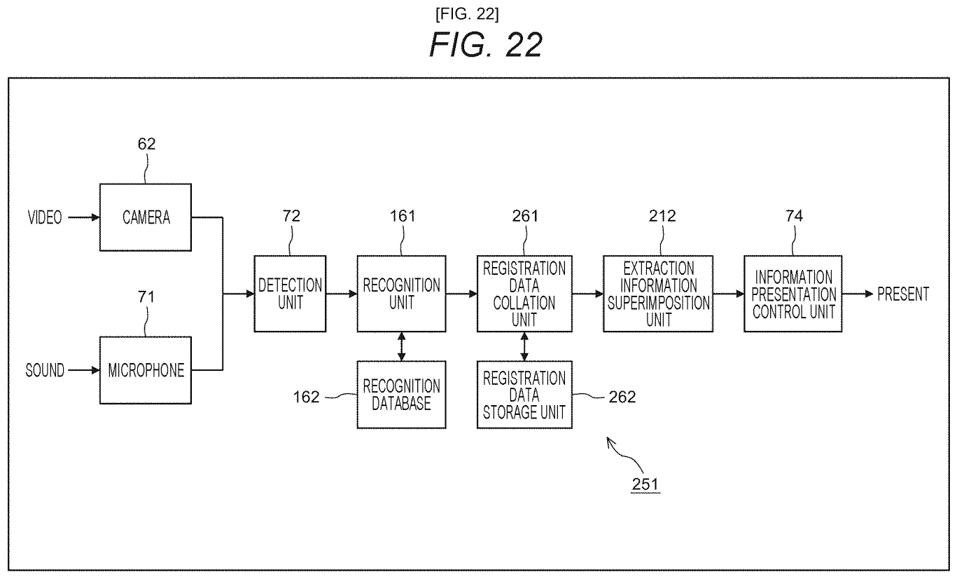

FIG. 22 is a block diagram illustrating a configuration example of an HMD system according to a sixth embodiment of the present technology.

FIG. 22 illustrates a configuration example of an HMD system 251 having the functions in the present technology in the ambient computing system 1 of FIG. 1.

The HMD system 251 of FIG. 22 is different from the HMD system 201 of FIG. 17 in that the detection result presentation & inquiry unit 211 is replaced with a registration data collation unit 261 and that a registration data storage unit 262 is added. Note that the registration data collation unit 261 and the registration data storage unit 262 correspond to the context management unit 28 in FIG. 1.

That is, the HMD system 251 of FIG. 22 is different from the HMD system 201 of FIG. 17 in that the HMD system 251 determines whether or not to respond to an intervener, instead of determining whether or not to respond to an intervener in accordance with the selection by the user.

The recognition unit 161 outputs the video data and the audio data supplied from the detection unit 72 and a result of recognition to the registration data collation unit 261.

On the basis of the result of recognition supplied from the recognition unit 161 and the data registered in the registration data storage unit 262, the registration data collation unit 261 determines whether or not a person who has spoken to the user while the user is viewing VR is a person to be responded to.

In a case where the person who has spoken to the user while the user is viewing VR is a person to be responded to, the registration data collation unit 261 outputs the video data, the audio data, and the result of recognition supplied from the recognition unit 161 to the extraction information superimposition unit 212 to present the video data, the audio data, and the result of recognition in the VR space.

If the person who has spoken to the user while the user is viewing VR is a person not to be responded to, the registration data collation unit 261 rejects presentation to the VR space. At this time, a message indicating that it is impossible to respond and a reason therefor, such as “I'm in the middle of something”, or the user's situation may be presented to the person who has spoken to the user.

In the registration data storage unit 262, for example, data regarding persons to be responded to and persons not to be responded to in a case where a person speaks to the user during VR viewing is registered in advance.

### <Process by HMD System>

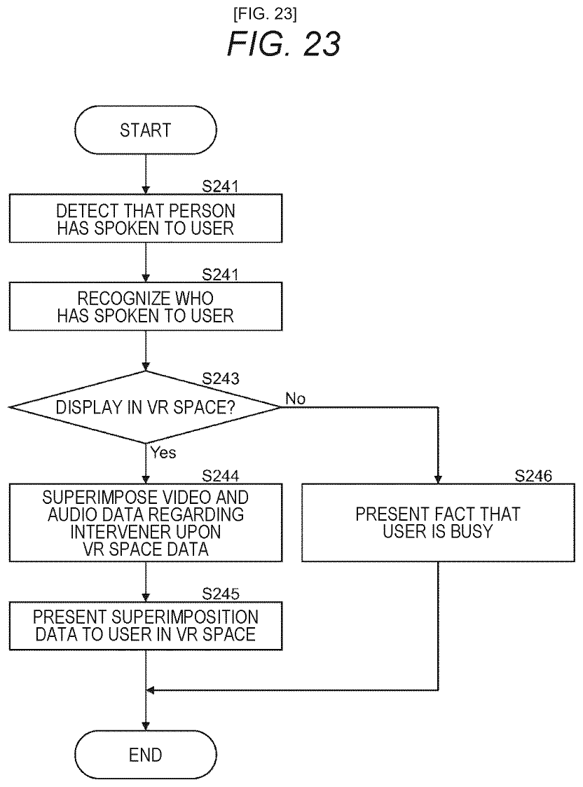

FIG. 23 is a flowchart illustrating a process by the HMD system 251 of FIG. 22.

For example, a child speaks, “Hey, hey, daddy”, to the user wearing the HMD 61 and viewing VR.

In step S241, the camera 62, the microphone 71, and the detection unit 72 detect that a person has spoken to the user as described above with reference to FIG. 6.

In step S242, by using the information registered in the recognition database 162, the recognition unit 161 refers to a result of detection of intervention supplied from the detection unit 72, and recognizes from video data who is the person speaking to the user.

In step S243, the registration data collation unit 261 determines whether or not to display the intervener in the VR space on the basis of the result of recognition of a person supplied from the recognition unit 161 and the data registered in the registration data storage unit 262.

In a case where the intervener is a person to be responded to, it is determined in step S243 that the intervener is to be displayed in the VR space, and the process proceeds to step S244. At this time, the registration data collation unit 261 outputs the video data, the audio data, and the result of recognition of a person supplied from the recognition unit 161 to the extraction information superimposition unit 212.

In step S244, the extraction information superimposition unit 212 extracts video and audio data regarding the intervener from the video data and the audio data supplied from the registration data collation unit 261, superimposes the extracted video and audio data regarding the intervener upon the data regarding the VR space 111, and outputs superimposition data to the information presentation control unit 74.

In step S245, the information presentation control unit 74 causes the presentation unit included in the HMD 61 to present, in the VR space 111, the superimposition data supplied from the extraction information superimposition unit 212, thereby presenting a video and a voice of the intervener to the user. The process then ends.

In a case where the intervener is a person not to be responded to, on the other hand, it is determined in step S243 that the intervener is not to be displayed in the VR space, and the process proceeds to step S246.

In step S246, the registration data collation unit 261 presents a fact that the user is busy (message) to the intervener as a voice, a text, or a video.

With the configuration described above, the HMD system 251 of FIG. 22 can save the user from having to select whether or not to respond to an intervener unlike the HMD system 201 of FIG. 17.

### <Example of Message>

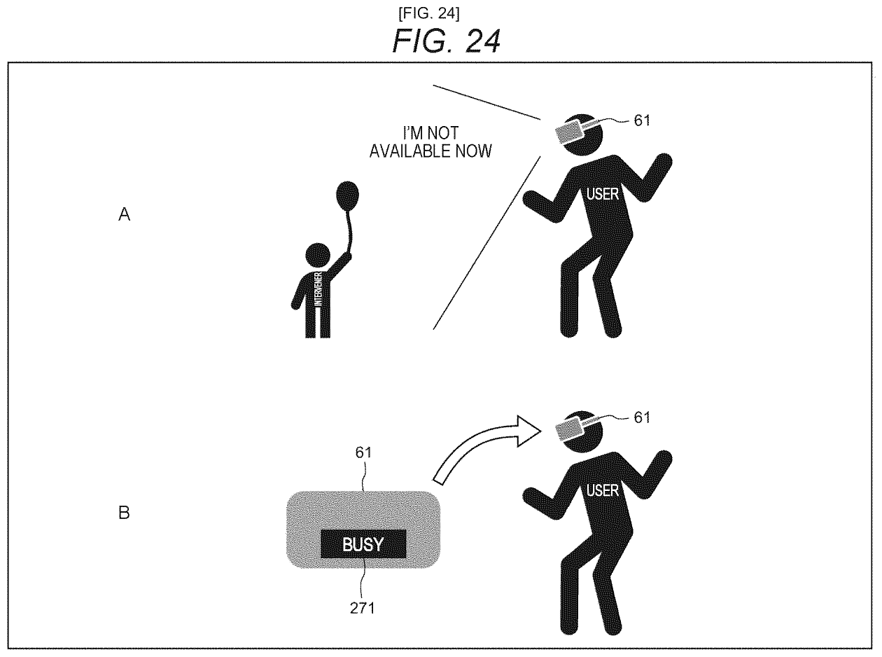

FIG. 24 is a diagram illustrating a method for presenting a message to an intervener.

In FIG. 24, two presentation methods are illustrated.

In A of FIG. 24, the HMD system 251 outputs a voice message such as “I'm not available now” to the outside from a speaker (not illustrated) of the HMD 61.

By listening to this message, the intervener can grasp that the user is in a situation where he/she is busy and cannot respond.

Note that, in this case, the user need not hear the voice message.

In B of FIG. 24, the HMD system 251 includes an outer presentation unit 271 outside the HMD 61, and presents a message such as “busy” to the outer presentation unit 271.

By viewing this message, the intervener can grasp that the user is in a situation where he/she is busy and cannot respond.

### 8. Seventh Embodiment of Present Technology (Intervention and Obstacle Detection)

### <Outline of HMD System>

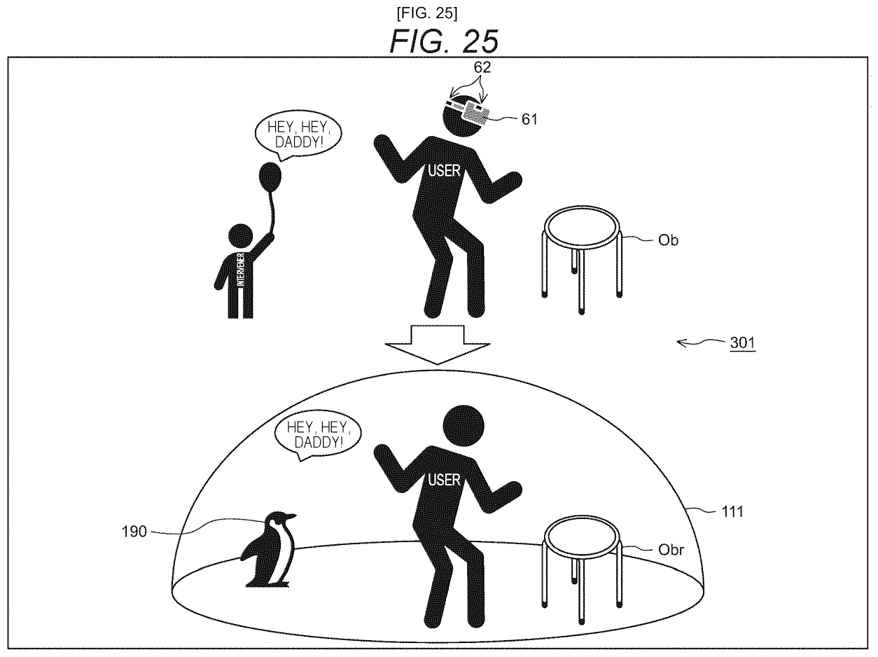

FIG. 25 is a diagram illustrating an outline of an HMD system according to a seventh embodiment of the present technology.

FIG. 25 illustrates a state of a user who uses an HMD system 301 having the functions in the present technology in the ambient computing system 1 of FIG. 1.

The HMD system 301 is, for example, a system combined with the HMD system 181 according to the fourth embodiment described above with reference to FIG. 15 and recognition of an object and reproduction in a VR space as described in Patent Document 1.

For example, another person (a child in FIG. 25) speaks from the outside, “Hey, hey, daddy”, to the user wearing the HMD 61 and viewing VR.

In the HMD system 301, the detection unit 72 detects an object Ob that can be an obstacle in addition to a fact that the child has spoken to the user with the camera 62 and the microphone 71 provided in the HMD 61.

The HMD system 301 then superimposes the avatar 190 generated from a video of the child and a virtual object Obr of the detected object Ob upon the data regarding the VR space 111 viewed by the user to present the data.

As illustrated in FIG. 25, by detecting not only the person but also the object Ob such as an obstacle and reproducing the virtual object Obr in the VR space 111 together with the avatar 190, an action on a real space such as “moving an obstacle” is possible, and it is also possible to reduce a risk of colliding with the object Ob without noticing the object Ob.

Note that although an example of combining the HMD system 181 according to the fourth embodiment and Patent Document 1 has been described, the present technology is not limited to the fourth embodiment, and may be combined with other embodiments as long as superimposed presentation upon the VR space is performed.

### 9. Eighth Embodiment of Present Technology (Sharing of VR Space)

### <Outline of HMD System>

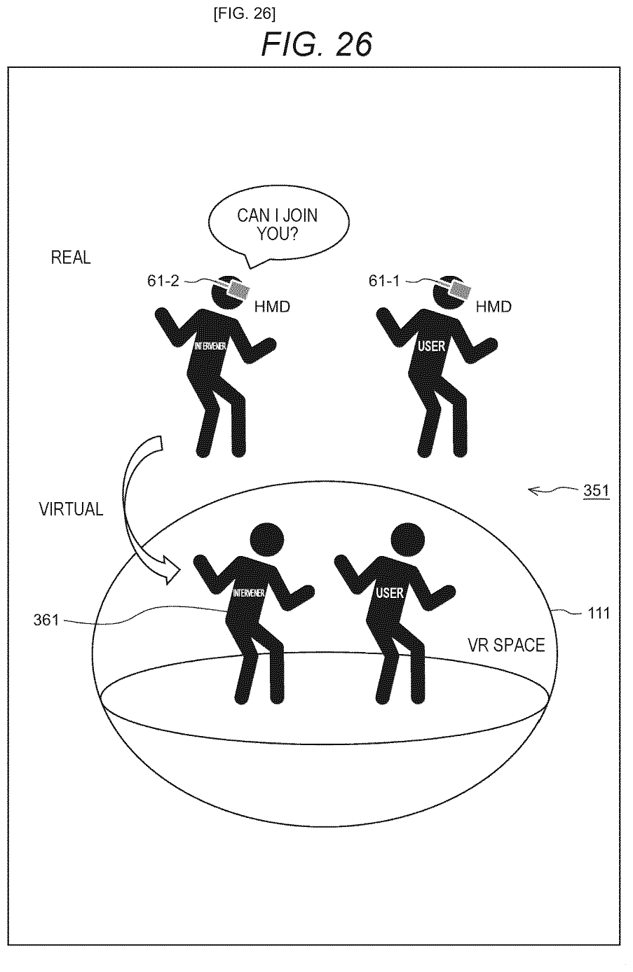

FIG. 26 is a diagram illustrating an outline of an HMD system according to an eighth embodiment of the present technology.

FIG. 26 illustrates a state of a user who uses an HMD system 351 having the functions in the present technology in the ambient computing system 1 of FIG. 1.

In the HMD system 201 according to the fifth embodiment described above with reference to FIG. 17, communication is continued between the user wearing the HMD 61 and viewing VR and an intervener in the real space, but in the HMD system 351 of FIG. 26, communication is continued between the user wearing an HMD 61-1 and viewing VR and an intervener wearing an HMD 61-2 and viewing VR.

For example, the intervener wearing the HMD 61-2 and viewing VR speaks, “Can I join you?”, to the user wearing the HMD 61-1 and viewing VR.

The HMD system 351 notifies the user of detection of the intervener, inquires of the user about a response to the intervener, and, in a case where the intervener is to be responded to in accordance with selection by the user, invites an avatar 361 of the intervener into the VR space 111.

As described above, in the HMD system 351 of FIG. 26, communication is continued between the user wearing the HMD 61-1 and viewing VR and the intervener wearing the HMD 61-2 and viewing VR.

### <Process by HMD System>

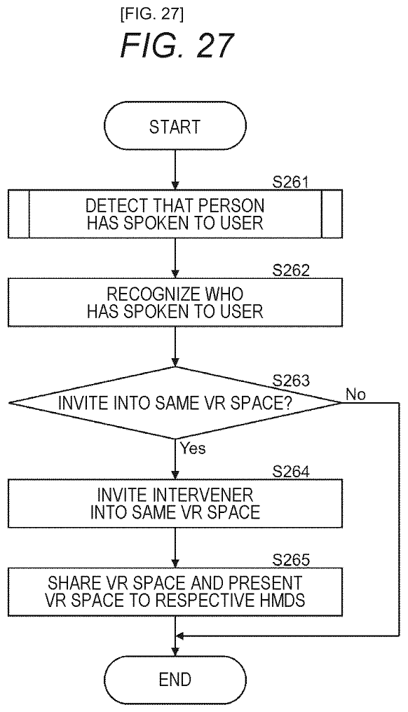

FIG. 27 is a flowchart illustrating a process by the HMD system 351 of FIG. 26.

Note that configuration of the HMD system 351 is basically similar to that of the HMD system 201 in FIG. 17 described above. Therefore, in FIG. 27, the configuration of the HMD system 351 will be described using the configuration of the HMD system 201 of FIG. 17 described above.

For example, the intervener wearing the HMD 61-2 and viewing VR speaks, “Can I join you?”, to the user wearing the HMD 61-1 and viewing VR.

In step S261, the camera 62, the microphone 71, and the detection unit 72 detect that a person has spoken to the user as described above with reference to FIG. 6.

In step S262, by using the information registered in the recognition database 162, the recognition unit 161 refers to a result of detection supplied from the detection unit 72, and recognizes from video data who is the person speaking to the user.

In step S263, the detection result presentation & inquiry unit 211 generates notification information for notifying of a result of recognition supplied from the recognition unit 161, and causes the presentation unit included in the HMD 61-1 to present the generated notification information and an inquiry as to whether or not to invite the intervener into the same VR space.

For example, a question, “Q has spoken to you. Invite Q into the VR space?”, is presented, and the user selects yes or no.

In step S264, the detection result presentation & inquiry unit 211 determines whether or not to invite the intervener into the VR space in accordance with the selection by the user. In a case where it is determined in step S264 that the intervener is not to be invited into the VR space, the process by the HMD system 351 in FIG. 27 ends.

In a case where it is determined in step S264 that the intervener is to be invited into the VR space, the process proceeds to step S265. At this time, the detection result presentation & inquiry unit 211 invites the intervener into the same VR space 111, for example, by communicating with the HMD 61-2 of the intervener.

In step S265, the extraction information superimposition unit 212 and the information presentation control unit 74 share the VR space 111 with the HMD 61-2 of the intervener, and present the avatars or the like to each other in the HMDs 61. That is, the extraction information superimposition unit 212 shares the data regarding the VR space 111 and presents the shared data regarding the VR space 111 to the information presentation control unit 74, so that the intervener is presented in the VR space 111 of the HMD 61-1 of the user as the avatar 361. The VR space 111 is also presented on a presentation unit of the intervener's HMD 61-2 together with the user's avatar. The process then ends.

As described above, the user can continuously interact with an intervener by inviting the intervener into the VR space 111.

### 10. Ninth Embodiment of Present Technology (Control According to Intervention Level)

### <First Control Process According to Intervention Level of HMD System>

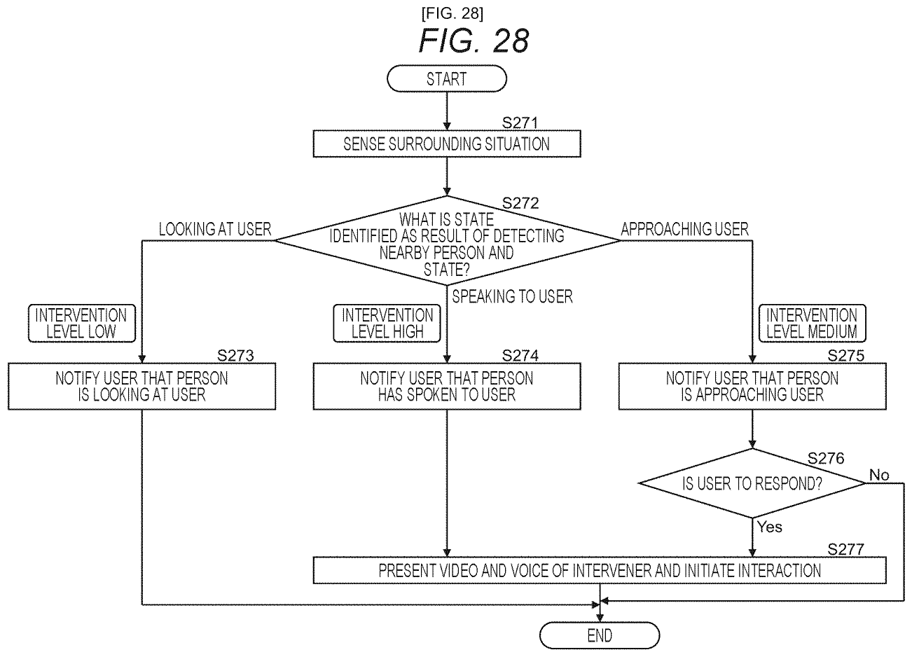

FIG. 28 is a flowchart illustrating a first control process according to an intervention level by an HMD system according to a ninth embodiment of the present technology.

The control process of FIG. 28 is, for example, the first control process for changing control in accordance with a condition in a case where there is external human intervention in the HMD system 201 according to the fifth embodiment described above with reference to FIG. 17.

Note that, in FIG. 28, for example, the intervention level is defined (set) on the basis of three human intervention conditions (types) of looking at, approaching, and speaking to the user, and control is performed.

In step S271, the camera 62 and the microphone 71 Sense a surrounding situation.

In step S272, the detection unit 72 determines a state identified as a result of detecting a nearby person and state.

In a case where it is determined in step S272 that the nearby person is looking at the user, the process proceeds to step S273.

In step S273, the detection result presentation & inquiry unit 211 determines that the intervention level is low, and notifies the user that a person is looking at him/her. That is, the detection result presentation & inquiry unit 211 generates notification information for notifying of the result of the detection (a person is looking at the user) supplied from the detection unit 72 via the recognition unit 161, and causes the presentation unit included in the HMD 61 to present the notification information. The first control process of FIG. 28 then ends.

In a case where it is determined in step S272 that a person has spoken to the user, the process proceeds to step S274.

In step S274, the detection result presentation & inquiry unit 211 determines that the intervention level is high, and notifies the user that a person has spoken to him/her. That is, the detection result presentation & inquiry unit 211 generates notification information for notifying of the result of the detection (a person has spoken to the user) supplied from the detection unit 72 via the recognition unit 161, and causes the presentation unit included in the HMD 61 to present the notification information. The process then proceeds to step S277.

In addition, in a case where it is determined in step S272 that the nearby person has spoken to the user, the process proceeds to step S275.

In step S275, the detection result presentation & inquiry unit 211 determines that the intervention level is medium, notifies the user that a person is approaching him/her, and presents an inquiry as to whether to respond to the approaching person.

That is, the detection result presentation & inquiry unit 211 generates notification information for notifying of the result of the detection (a person is approaching the user) supplied from the detection unit 72 via the recognition unit 161 and an inquiry as to whether to respond to the approaching person, and causes the presentation unit included in the HMD 61 to present the notification information.

In step S276, the detection result presentation & inquiry unit 211 determines whether or not to respond in accordance with selection by the user with respect to the presentation. In a case where it is determined in step S276 that the approaching person is not to be responded to, the first control process of FIG. 28 ends.

In a case where it is determined in step S276 that the approaching person is to be responded to, the process proceeds to step S277.

In step S277, the extraction information superimposition unit 212 extracts a video and a voice of the intervener from the video data and the audio data, and, for example, the information presentation unit 74 presents the video and the audio of the intervener to (the VR space of) the presentation unit to initiate an interaction. The first control process of FIG. 28 then ends.

Note that although an example in which the intervention level is defined in accordance with the condition of intervention and the control is performed has been described in the above description, the intervention level may be defined as follows in accordance with a type of intervention and a condition thereof (a degree of intervention).

For example, the intervention level may be defined as low<medium<high for distance of long<medium<short. The intervention level may be defined as low<medium<high for an approach speed of low<medium<high. The intervention level may be defined as low<medium<high for a volume of speaking voice of low<medium<high.

Furthermore, as described above, there are three types of control methods, that is, notifying the user of the state of the intervener, notifying the user of the state of the intervener and inquiring of the response method, and notifying the user of the state of the intervener and automatically determining and starting the response method, and one of the control methods is selected in accordance with the intervention level.

Lastly, there are three types of response methods, that is, not responding to the intervener (do nothing or notify the intervener that the user cannot respond), presenting the state of the intervener to the user by video or voice, and starting an interaction mode between the intervener and the user, and one of the response methods is selected in accordance with the intervention level.

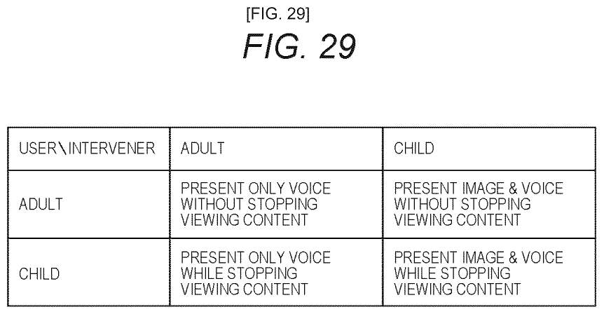

FIG. 29 is a diagram illustrating a control method based on whether the user and the intervener are adults Or children.

There are the following five types of control methods based on whether the user and the intervener are adults or children.
(1) Start an interaction mode in which only a voice is presented in the VR space without stopping viewing content
(2) Start an interaction mode in which an image and a voice are presented in the VR space without stopping viewing content
(3) Start an interaction mode in which only a voice is presented in the VR space while stopping viewing content
(4) Start an interaction mode in which an image and a voice are presented in the VR space while stopping viewing content (5) No response to the intervener

For example, as illustrated in FIG. 29, settings are made in advance such that, in a case where the user is an adult and the intervener is an adult, the control method (1) is used among the above-described control methods (1) to (5), that is, an interaction mode in which only a voice is presented in the HMD is established without stopping viewing content.

Settings are made in advance such that, in a case where the user is an adult and the intervener is a child, the control method (2) is used among the above-described control methods (1) to (5), that is, an interaction mode in which an image and a voice are presented in the HMD is established without stopping viewing content.

Settings are made in advance such that, in a case where the user is a child and the intervener is an adult, the control method (3) is used among the above-described control methods (1) to (5), that is, an interaction mode in which only a voice is presented in the HMD is established while stopping viewing content.

Settings are made in advance such that, in a case where the user is a child and the intervener is a child, the control method (4) is used among the above-described control methods (1) to (5), that is, an interaction mode in which an image and a voice are presented in the HMD is established while stopping viewing content.

Note that, an optimal pattern can vary depending on the use case, the assignment of the control method for each condition is preferably changeable.

Furthermore, the determination as to whether the intervener is a child or an adult may be made from a video, and the determination as to whether the user is a child or an adult may be set in advance.

Moreover, an optimum control method for each condition of an adult or a child may be changed in accordance with the use case.

For example, in a pattern in which an adult speaks to a child who is viewing VR, the settings may be changed such that the adult can forcibly stop the VR viewing of the child.

For example, the settings may be changed such that the control method (4) is automatically selected, so that the adult can interact with the child without disturbing the child's VR viewing when speaking to the child.

For example, the settings may be changed such that the control method (1) is automatically selected when the adult speaks to the child.

Although an example in which an adult speaks to a child has been described above, the settings are not made as described above when a child speaks to an adult.

Note that although a case where attributes of the user and the intervener are an adult or a child has been described in the above description, the attributes may be an elderly person or a young person, or may be gender.

Here, the control methods (1) to (5) described above can be automatically changed depending on a type of content being viewed.

For example, the type of viewing content and a corresponding control method may be as follows.

In a case where the viewing content is a game, the control method (1) is selected because the game is not desired to be stopped.

In a case where the viewing content is dynamic content such as a movie, the control method (4) is selected because it is OK to stop the content and there is a possibility that a nearby video and voice cannot be presented unless the viewing content is stopped.

In a case where the viewing content is static content such as picture viewing, investigation, or work, the control method (2) is selected because the external situation can be grasped without stopping the content.

In a case where the viewing content is a conference (online meeting or the like), the control method (5) is selected because it is desired to restrict external intervention.

### <Second Control Process According to Intervention Level of HMD System>

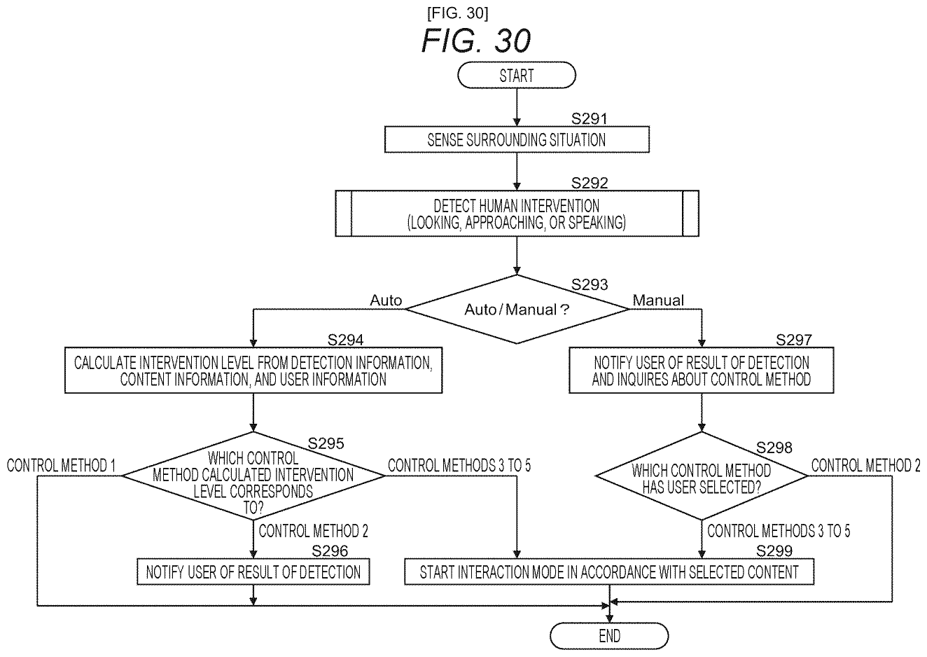

FIG. 30 is a flowchart illustrating a second control process according to the intervention level by the HMD system according to the ninth embodiment of the present technology.

The control process of FIG. 30 is, for example, the second control process for changing control in accordance with a condition in a case where there is external human intervention in the HMD system 201 according to the fifth embodiment described above with reference to FIG. 17.

Note that, in the second control process, [Auto or Manual], [type of control method], [calculation of intervention level], and [control method corresponding to intervention level] are set in advance as follows.

### [Auto or Manual]

Whether the system performs automatic control (Auto) or the user selects a control method (Manual) is set in advance.

[Type of control method]

The following control methods 1 to 5 are set in advance.
Control method 1: Do nothing
Control method 2: Notify the user that there is an intervener and of the situation
Control method 3: Perform control method 2 and start an interaction mode in which only a voice is presented in the HMD without stopping viewing content
Control method 4: Perform control method 2 and start an interaction mode in which an image and a voice are presented in the HMD without stopping viewing content
Control method 5: Perform control method 2 and start an interaction mode in which an image and a voice are presented in the HMD while stopping viewing content Note that the intervention level is control method 1<control method 2<control method 3<control method 4<control method 5.

### [Calculation of Intervention Level]

A weight of the intervention level (a value of 0.0 to 1.0) is set in advance for each of the following elements.
State of person (looking, approaching, or speaking): Ws
Type of viewing content (static content, dynamic content, game, or meeting): Wc
User attribute (child, adult, etc.): Wu
Intervener attribute (child, adult, or person is registered in advance): Wo

The intervention level (Li) is then calculated from the weights as in the following equation (1).

Li=Ws*Wc*Wu*Wo . . . (1)

### [Intervention Level and Corresponding Control Method]

In order to determine the control method corresponding to the intervention level, a control method determination table indicating the control methods corresponding to the intervention levels is set in advance.

### <Example of Control Method Determination Table>

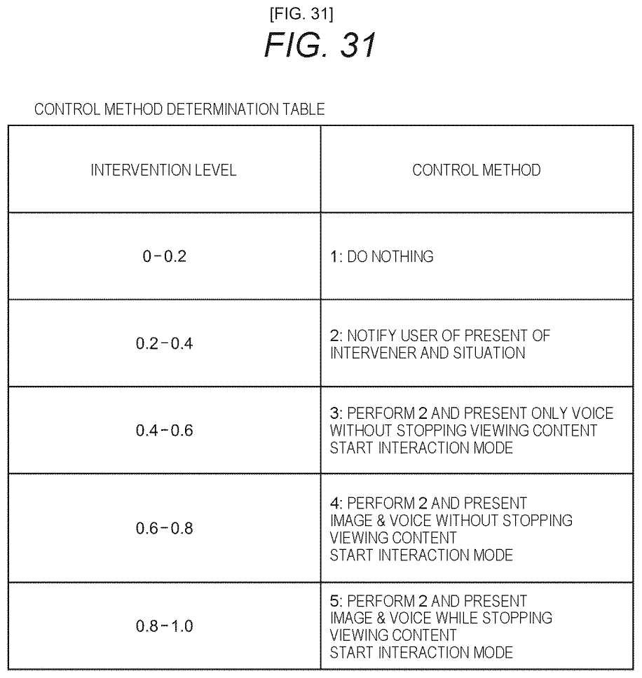

FIG. 31 is a diagram illustrating an example of the control method determination table.

In the case of the intervention levels 0 of to 0.2, control method 1 is performed.

In the case of the intervention levels of 0.2 to 0.4, control method 2 is performed.

In the case of the intervention levels of 0.4 to 0.6, control method 3 is performed after control method 2 is performed.

In the case of the intervention levels of 0.6 to 0.8, control method 4 is performed after control method 2 is performed.

In the case of the intervention levels of 0.8 to 1.0, control method 5 is performed after control method 2 is performed.

Next, referring back to FIG. 30, the second control process will be described.

In step S291, the camera 62 and the microphone 71 sense a surrounding situation.

In step S292, the detection unit 72 detects human intervention (looking, approaching, or speaking).

In step S293, the detection result presentation & inquiry unit 211 determines whether Auto or Manual is employed. In a case where it is determined in step S273 that the automatic setting is specified, that is, Auto is employed, the process proceeds to step S294.

In step S294, the detection result presentation & inquiry unit 211 calculates the intervention level from detection information, content information, and user information.

In step S295, the detection result presentation & inquiry unit 211 determines which control method the calculated intervention level corresponds to. In a case where it is determined in step S295 that the calculated intervention level corresponds to control method 1, the second control process of FIG. 30 ends.

In a case where it is determined in step S295 that the calculated intervention level corresponds to control method 2, the process proceeds to step S296. In step S296, the detection result presentation & inquiry unit 211 notifies the user of a result of the detection. The second control process of FIG. 30 then ends.

In a case where it is determined in step S295 that the calculated intervention level corresponds to control methods 3 to 5, the process proceeds to step S299.

In a case where it is determined in step S293 that the control method is to be set in consultation with the user, that is, Manual is employed, the process proceeds to step S297.

In step S297, the detection result presentation & inquiry unit 211 notifies the user of the result of the detection, and inquires of the user about the control method.

In step S298, the detection result presentation & inquiry unit 211 determines which control method the user has selected. Note that since the notification is essential in the example in FIG. 30, control method 1 is not included in the options. In a case where it is determined in step S298 that the user has selected control method 2, the second control process of FIG. 30 ends.

In a case where it is determined in step S298 that the user has selected control methods 3 to 5, the process proceeds to step S299.

In step S299, the extraction information superimposition unit 212 extracts a video and a voice of the intervener from the video data and the audio data, and the information presentation unit 74 presents the video and the audio of the intervener to the presentation unit or the VR space to start an interaction mode in accordance with the selected content (content of the control method). The second control process of FIG. 30 then ends.

### 11. Others

### <Application Examples of Present Technology>

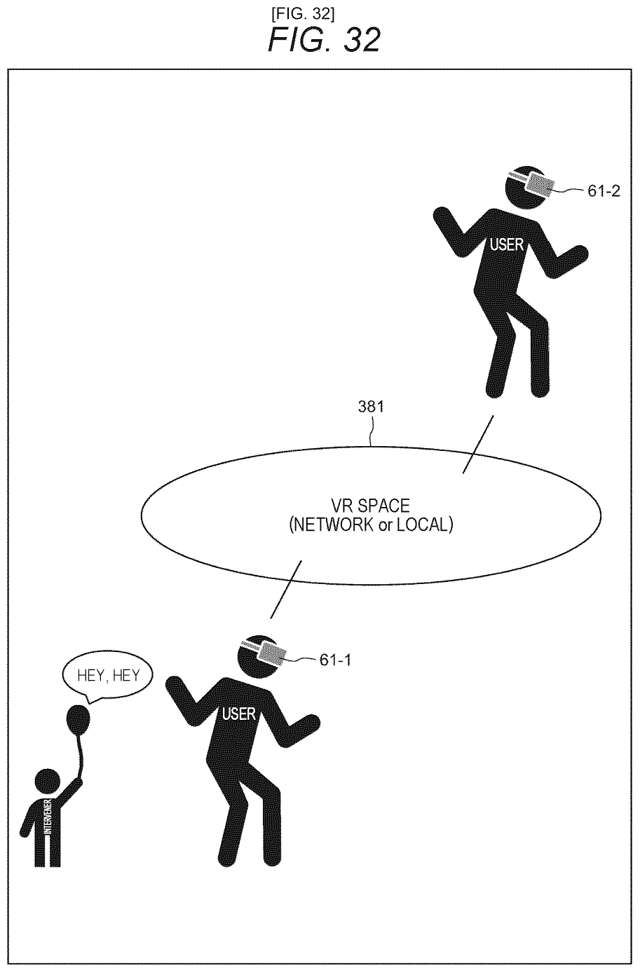

FIG. 32 is a diagram illustrating an example of the VR space viewed or experienced by the user.

In FIG. 32, a VR space 381 viewed or experienced by the user is illustrated.

The VR space 381 viewed or experienced by the user wearing the HMD 61-1 may be a locally developed space.

The VR space 381 may be a space like a metaverse that is developed on a network and in which a plurality of users participates, such as the user wearing the HMD 61-1 and the user wearing the HMD 61-2.

Furthermore, the present technology is intended for a user wearing an HMD that operates for a dedicated application, a game, or the like, and intervention from another person in a real space where the user is.

Here, the device for viewing the VR space is not limited to an HMD, and may be a user device, such as a VR headset, that blocks an external sight and sound by viewing the VR space.

Note that the VR headset is a headset used for, for example, VR operating in a dedicated application, VR operating in a dedicated game machine, or the like.

### <Effects of Present Technology>

In the present technology, an external intervener with respect to a user wearing a user device that blocks an external sight and sound is detected, and control for presenting information regarding the detected intervener to the user is performed.

As a result, it is possible to support the user in responding promptly and reduce risks.

### <Configuration Example of Computer>

The series of processing steps described above may be executed by hardware, or may be executed by software. In a case where the series of processing steps is executed by software, a program included in the software is installed from a program recording medium on a computer incorporated in dedicated hardware, a general-purpose personal computer, or the like.

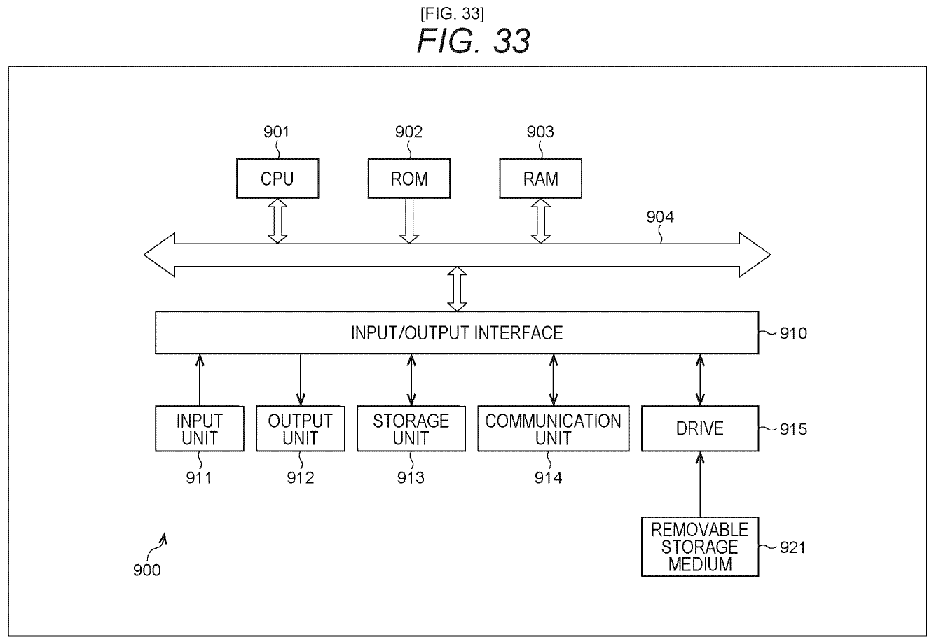

FIG. 33 is a block diagram illustrating a configuration example of hardware of a computer 900 that performs the above-described series of processing by a program.

A central processing unit (CPU) 901, a read only memory (ROM) 902, and a random access memory (RAM) 903 are connected to each other by a bus 904.

The bus 904 is further connected to an input/output interface 910. An input unit 911 including a keyboard, a mouse, and the like and an output unit 912 including a display, a speaker, and the like are connected to the input/output interface 910. Furthermore, a storage unit 913 including a hard disk, a nonvolatile memory, or the like, a communication unit 914 including a network interface or the like, and a drive 915 that drives a removable storage medium 921 are connected to the input/output interface 910.

In the computer 900 configured as described above, for example, the CPU 901 loads the program stored in the storage unit 913 into the RAM 903 via the input/output interface 910 and the bus 904 and executes the program, thereby performing the above-described series of processing.

For example, the program executed by the CPU 901 is stored in the removable storage medium 921, or provided via a wired or wireless transmission medium such as a local area network, the Internet, or digital broadcasting, and then installed in the storage unit 913.

Note that the program to be executed by the computer may be a program in which processing is executed in a time series in the order described herein, or may be a program in which processing is executed in parallel or at a necessary timing such as a timing at which retrieving is performed, or the like.

Note that, in the present specification, a system refers to a set of a plurality of components (devices, modules (parts), or the like), and it does not matter whether or not all the components are located in the same housing. Therefore, a plurality of devices housed in separate housings and connected to each other via a network and one device including a plurality of modules housed in one housing are both systems.

Furthermore, the effects described herein are merely examples and not restrictive, and there may also be other effects.

Embodiments of the present technology are not limited to the embodiments described above, and various modifications can be made without departing from the scope of the present technology.

For example, the present technology may be configured as cloud computing in which one function is shared by a plurality of devices via a network and processed in cooperation.

Furthermore, each step described in the flowcharts described above may be performed by a single device, or may be performed by a plurality of devices in a shared manner.

Moreover, in a case where a single step includes a plurality of processes, the plurality of processes included in the single step may be performed by a single device or performed by a plurality of devices in a shared manner.

### Examples of Combinations of Configurations

The present technology can also be configured as follows.

(1)

An information processing device including:
a detection unit that detects an external intervener with respect to a user wearing a user device that blocks an external sight and sound; and
a presentation control unit that performs control for presenting information regarding the detected intervener to the user.
   (2)

The information processing device according to (1), in which
the presentation control unit performs control for presenting, as information regarding the intervener, notification information for notifying of presence of the intervener.
   (3)

The information processing device according to (1), in which
the presentation control unit performs control for presenting, as information regarding the intervener, at least one of a video of the intervener, an avatar of the intervener, and a voice of the intervener.
   (4)

The information processing device according to any one of (1) to (3), in which
the presentation control unit performs control for presenting the information regarding the intervener in a VR space viewed with the device.
   (5)

The information processing device according to any one of (1) to (4), further including:
a response determination unit that determines whether or not to respond to the intervener, in which
in a case where it is determined that the intervener is to be responded to, the presentation control unit performs control for presenting the information regarding the intervener.
   (6)

The information processing device according to (5), in which
in a case where it is determined that the intervener is not to be responded to, the presentation control unit performs control for presenting, to the intervener, information indicating that the user is unable to respond.
   (7)

The information processing device according to (5), in which
the response determination unit determines whether or not to respond to the intervener in accordance with selection by the user.
   (8)

The information processing device according to (5), further including:
a response storage unit that stores in advance information indicating whether or not to respond to each of the interveners, in which
the response determination unit determines whether or not to respond to the intervener in accordance with the information indicating whether or not to respond to each of the interveners.
   (9)

The information processing device according to (5), in which
the response determination unit determines whether or not to respond to the intervener in accordance with an intervention level.
   (10)

The information processing device according to (9), in which
the intervention level is set in accordance with a type of intervention or a degree of intervention of the intervener.
   (11)

The information processing device according to (10), in which
the type of intervention includes at least one of a motion of speaking to the user, a motion of approaching the user, or a motion of looking at the user.
   (12)

The information processing device according to (10), in which
the degree of intervention of the intervener includes at least one of an a distance when approaching the user, a speed of approaching the user, or a volume of a voice speaking to the user.
   (13)

The information processing device according to (9), in which
the intervention level is set in accordance with at least one of an attribute of the user and an attribute of the intervener.
   (14)

The information processing device according to (13), in which
the attribute is an adult or a child.
   (15)

The information processing device according to (9), in which
the intervention level is set in accordance with a type of content that the user is viewing.
   (16)

The information processing device according to any one of (1) to (15), in which
the detection unit detects the intervener using at least one of video data captured and generated by an imaging unit and audio data collected and generated by a sound collection unit.
   (17)

The information processing device according to (16), in which
the imaging unit and the sound collection unit are provided in the user device.
   (18)

The information processing device according to any one of (1) to (17), in which
the user device is a head-mounted display.
   (19)

An information processing method including:
by an information processing device,
detecting an external intervener with respect to a user wearing a device that blocks an external sight and sound, and performing control for presenting information regarding the detected intervener to the user.
(20) A program causing a computer to function as:
a detection unit that detects an external intervener with respect to a user wearing a device that blocks an external sight and sound; and
a presentation control unit that performs control for presenting information regarding the detected intervener to the user.

### REFERENCE SIGNS LIST

1 Ambient computing system
21 User interface
22 Environmental prior information obtaining unit
23 User prior information obtaining unit
24 Cooperative sensing unit
25 Surrounding environment detection unit
26 User state detection unit
27 User response detection unit
28 Context management unit
29 Device control unit
30 Environmental context model storage unit
31 User context model storage unit
32 Service list storage unit
51 HMD system
61, 61-1, 61-2 HMD
62 Camera
71 Microphone
72 Detection unit
73 Notification information generation unit
74 Information presentation control unit
81 Person detection section
82 Motion determination section
83 Utterance section detection section
84 Speaker recognition section
85 Speaker data DB
86 Intervention detection section
91 Camera
92 Microphone
101 HMD system
111 VR space
131 Notification information superimposition unit
151 HMD system
161 Recognition unit
162 Recognition database
181 HMD system
190 Avatar
191 Skeleton data extraction unit
192 Three-dimensional information reconstruction unit
201 HMD system
211 Detection result presentation & inquiry unit
212 Extraction information superimposition unit
231 Omnidirectional camera
232 Virtual image
241 Front camera
251 HMD system
261 Registration data collation unit
262 Registration data storage unit
271 Outer presentation unit
301 HMD system
351 HMD system
361 Avatar
381 VR space

1. An information processing device comprising:
a detection unit that detects an external intervener with respect to a user wearing a user device that blocks an external sight and sound; and
a presentation control unit that performs control for presenting information regarding the detected intervener to the user.

2. The information processing device according to claim 1, wherein
the presentation control unit performs control for presenting notification information for notifying of presence of the intervener.

3. The information processing device according to claim 1, wherein
the presentation control unit performs control for presenting at least one of a video of the intervener, an avatar of the intervener, and a voice of the intervener.

4. The information processing device according to claim 1, wherein
the presentation control unit performs control for presenting the information regarding the intervener in a VR space viewed with the device.

5. The information processing device according to claim 1, further comprising:
a response determination unit that determines whether or not to respond to the intervener, wherein
in a case where it is determined that the intervener is to be responded to, the presentation control unit performs control for presenting the information regarding the intervener.

6. The information processing device according to claim 5, wherein
in a case where it is determined that the intervener is not to be responded to, the presentation control unit performs control for presenting, to the intervener, information indicating that the user is unable to respond.

7. The information processing device according to claim 5, wherein
the response determination unit determines whether or not to respond to the intervener in accordance with selection by the user.

8. The information processing device according to claim 5, further comprising:
a response storage unit that stores in advance information indicating whether or not to respond to each of the interveners, wherein
the response determination unit determines whether or not to respond to the intervener in accordance with the information indicating whether or not to respond to each of the interveners.

9. The information processing device according to claim 5, wherein
the response determination unit determines whether or not to respond to the intervener in accordance with an intervention level.

10. The information processing device according to claim 9, wherein
the intervention level is set in accordance with a type of intervention or a degree of intervention of the intervener.

11. The information processing device according to claim 10, wherein
the type of intervention includes at least one of a motion of speaking to the user, a motion of approaching the user, or a motion of looking at the user.

12. The information processing device according to claim 10, wherein
the degree of intervention of the intervener includes at least one of an a distance when approaching the user, a speed of approaching the user, or a volume of a voice speaking to the user.

13. The information processing device according to claim 9, wherein
the intervention level is set in accordance with at least one of an attribute of the user and an attribute of the intervener.

14. The information processing device according to claim 13, wherein
the attribute is an adult or a child.

15. The information processing device according to claim 9, wherein
the intervention level is set in accordance with a type of content that the user is viewing.

16. The information processing device according to claim 1, wherein
the detection unit detects the intervener using at least one of video data captured and generated by an imaging unit and audio data collected and generated by a sound collection unit.

17. The information processing device according to claim 16, wherein
the imaging unit and the sound collection unit are provided in the user device.

18. The information processing device according to claim 1, wherein
the user device is a head-mounted display.

19. An information processing method comprising:
by an information processing device,
detecting an external intervener with respect to a user wearing a device that blocks an external sight and sound, and performing control for presenting information regarding the detected intervener to the user.

20. A program causing a computer to function as:
a detection unit that detects an external intervener with respect to a user wearing a device that blocks an external sight and sound; and
a presentation control unit that performs control for presenting information regarding the detected intervener to the user.
